(19) United States
(12) Patent Application Publication
(10) Pub. No.: US 2010/0332324 A1
(43) Pub. Date: Dec. 30, 2010

(54) PORTAL SERVICES BASED ON INTERACTIONS WITH POINTS OF INTEREST DISCOVERED VIA DIRECTIONAL DEVICE INFORMATION

(75) Inventors: Moe Khosravy, Bellevue, WA (US); Lev Novik, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/491,519

(22) Filed: Jun. 25, 2009

(51) Int. Cl. G06Q 30/00; G06F 17/30

(52) U.S. Cl. 705/14.53; 705/14.58; 707/769; 707/759; 707/754

(57) ABSTRACT

With the addition of directional information in the environment, a variety of service(s) can be provided on top of user identification or interaction with specific object(s) of interest by pointing at the objects. Items discovered through direction-based location services can be designated for present or later interaction, with information about those interactions uploaded to intelligent portal services exposed via one or more networks. Device users can interact with the portal services at a later time after an intelligent analysis has been applied to data representing the user's interactions, enabling a variety of scenarios, such as recommendation engines, sharing engines, shopping scenarios, etc. via the portal services.

### TECHNICAL FIELD

The subject disclosure relates to portal service(s) for exposing custom user content based on user interactions with points of interest identified in connection with the use of one or more location and direction-based services.

### BACKGROUND

By way of background concerning some conventional systems, mobile devices, such as portable laptops, PDAs, mobile phones, navigation devices, and the like have been equipped with location based services, such as global positioning system (GPS) systems, WiFi, cell tower triangulation, etc. that can determine and record a position of mobile devices. For instance, GPS systems use triangulation of signals received from various satellites placed in orbit around Earth to determine device position. A variety of map-based services have emerged from the inclusion of such location based systems that help users of these devices to be found on a map and to facilitate point to point navigation in real-time and search for locations near a point on a map.

However, such navigation and search scenarios are currently limited to displaying relatively static information about endpoints and navigation routes. While some of these devices with location based navigation or search capabilities allow update of the bulk data representing endpoint information via a network, e.g., when connected to a networked portable computer (PC) or laptop, such data again becomes fixed in time. Accordingly, it would be desirable to provide a set of richer experiences for users than conventional experiences predicated on location and conventional processing of static bulk data representing potential endpoints of interest.

Another problem is that a user on the go being informed of nearby points of interest (POIs) based on location information may not always have the time to interact with the POIs, or to sift through irrelevant information such as POIs away from which a user is moving. Moreover, even if the user does have time, the device may not have the capabilities to support a full user experience to engage the user with, e.g., due to limited hardware, such as a limited keypad, screen space, etc.

Another problem is that a user searching for information about potential POIs, without having identified them previously in any way, may be overwhelmed by the number of potential POIs and the volume of information available.

The above-described deficiencies of today's location based systems and devices are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Direction based pointing services are provided for portable devices or mobile endpoints. Mobile endpoints can include a positional component for receiving positional information as a function of a location of the portable electronic device, a directional component that outputs direction information as a function of an orientation of the portable electronic device and a processing engine that processes the positional information and the direction information to determine a subset of points of interest relative to the portable electronic device as a function of the positional information and/or the direction information.

Devices or endpoints can include compass(es), e.g., magnetic or gyroscopic, to determine a direction and location based systems for determining location, e.g., GPS. To supplement the positional information and/or the direction information, devices or endpoints can also include component(s) for determining speed and/or acceleration information for processing by the engine, e.g., to aid in the determination of gestures made with the device.

With the addition of directional information in the environment, a variety of portal service(s) can be provided on top of user identification or interaction with specific object(s) of interest. For instance, when a user points at a particular item at a particular location or place, this creates an opportunity for anyone having an interest in that particular item to communicate with the user regarding that item or related items at a point in time when the user's focus is on the particular item. User context for the interaction can also be taken into account to supplement the provision of one or more interactive direction based services.

Moreover, sometimes either the device user and/or the publishers of content associated with a POI with which a user interacts, will wish to delay the interaction with the POI and associated content. Device users are thus provided with relevant content about endpoints at relevant times, which may not be the time of initial contact with the POI.

Through access to one or more embodiments of a portal that “carries over” user data, including user data resulting from POIs identified during use of one or more direction based services, to a portal service to which users can connect anytime from any device to view a customized user POI package based on an intelligent analysis. A portal, or portal service, allows the user to access information about the POI from any device with network access, at any time. The portal also allows the user to take advantage of additional features such as observing trends in the user's own interest in POIs, collaborative filtering with other users about POIs, etc. Using the portal, the user may interact with POIs by category, e.g., restaurants, or by sub-category, e.g., sushi restaurants. The user may also receive advertisements or offers from the POIs, or receive feedback from other users about the POIs, etc. The portal service may be provided free of charge in exchange for the placement of advertisements by POIs within the portal.

These and other optional embodiments are described in more detail below.

### BRIEF DESCRIPTION OF THE DRAWINGS

Various non-limiting embodiments are further described with reference to the accompanying drawings in which:

FIG. 1 is a block diagram of a non-limiting architecture for interaction scenarios in accordance with one or more embodiments;

FIG. 2 is a block diagram of another non-limiting architecture for interaction scenarios;

FIG. 3 is a flow diagram of a non-limiting process for interaction with marked points of interest;

FIG. 4 is a flow diagram of a non-limiting process for interaction with marked points of interest;

FIG. 5 is a block diagram of a device illustrating a specific apparatus for interacting with points of interest in connection with direction based services, or for marking points of interest for delayed interaction in connection with direction based services and a non-limiting set of services offered for such interactions;

FIG. 6 is a flow diagram of a non-limiting process for facilitating delayed interaction with points of interest;

FIG. 7 is an exemplary UI for a mobile endpoint device which has identified the Eiffel Tower as a point of interest in accordance with one or more embodiments;

FIG. 8 is an exemplary UI for a mobile endpoint device which is interacting with the Eiffel Tower as a point of interest using the portal service in accordance with one or more embodiments;

FIG. 9 is an exemplary UI for a small form factor mobile endpoint device (e.g. cell phone, PDA, etc.) which has identified the Eiffel Tower as a point of interest in accordance with one or more embodiments;

FIG. 10 is an exemplary UI for a computing device which is performing delayed interaction with the Eiffel Tower as a point of interest using the portal service in accordance with one or more embodiments;

FIG. 11 is an exemplary UI for a computing device which is interacting with a golf club;

FIG. 12 is a block diagram of an exemplary architecture for a system that supports delayed interaction with points of interest utilizing cloud services in accordance with one or more embodiments;

FIG. 13 illustrates an exemplary sequence for delayed interaction with POIs at a location as a future advertising source;

FIG. 14 is a block diagram illustrating a non-limiting example of an architecture including a portal service for interacting with points of interest;

FIG. 15 is a block diagram illustrating market players in an overall advertising model established based on interest in satisfying the delayed interactions defined according to one or more embodiments herein;

FIG. 16 is a block diagram illustrating a variety of ways in which user intent can be inferred or implied with respect to points of interest;

FIGS. 17 and 18 illustrate representative scenarios where a delayed interaction facilitates a better timing for a transaction regarding a given item of interest;

FIG. 19 is a block diagram illustrating the formation of motion vectors for use in connection with location based services;

FIG. 20, FIG. 21 and FIG. 22 illustrate aspects of algorithms for determining intersection endpoints with a pointing direction of a device;

FIG. 23 represents a generic user interface for a mobile device for representing points of interest based on pointing information;

FIG. 24 represents some exemplary, non-limiting alternatives for user interfaces for representing point of interest information;

FIG. 25 represents some exemplary, non-limiting fields or user interface windows for displaying static and dynamic information about a given point of interest;

FIG. 26 illustrates a sample overlay user interface for overlaying point of interest information over a camera view of a mobile device;

FIG. 27 illustrates a process for predicting points of interest and aging out old points of interest in a region-based algorithm;

FIG. 28 illustrates a first process for a device upon receiving a location and direction event;

FIG. 29 illustrates a second process for a device upon receiving a location and direction event;

FIG. 30 is a block diagram representing an exemplary non-limiting networked environment in which embodiment(s) may be implemented; and

FIG. 31 is a block diagram representing an exemplary non-limiting computing system or operating environment in which aspects of embodiment(s) may be implemented.

### DETAILED DESCRIPTION

### Overview

As discussed in the background, among other things, current location services systems and services, e.g., GPS, cell triangulation, P2P location service, such as Bluetooth, WiFi, etc., tend to be based on the location of the device only, and tend to provide static experiences that are not tailored to a user because the data about endpoints of interest is relatively static, or fixed in time.

At least partly in consideration of these deficiencies of conventional location based services, various embodiments of a portable device are provided that enable users to point a device in a direction, determine a set of system points of interest based on the direction pointed to by the device, and receive information about the points of interest or otherwise interact with the points of interest, or defer interaction with a point of interest of the set to a point later in time, enabling a rich set of scenarios empowering users of direction-based services to receive relevant information at optimal times.

Thus, items discovered through direction-based location services can be designated for present or later interaction, with information about those interactions uploaded to intelligent portal services exposed via one or more networks. Device users can interact with the portal services at a later time after an intelligent analysis has been applied to data representing the user's interactions, enabling a variety of scenarios, such as recommendation engines, sharing engines, shopping scenarios, etc. via the portal services.

A present interaction generates data that can be uploaded to the portal and a deferred interaction can be performed by accessing a portal service from any device. In either case, data is generated that can be leveraged by a portal service in providing custom POI or related content to the user. Present interactions by users with devices generate a first kind of user data, and marking POIs for later interaction generates a second kind of user data, both of which kinds of data can be analyzed by a portal service to learn something about the user. In this regard, all kinds of user data, explicit or implicit, can form the basis of an intelligent user portal service that analyzes the user data and presents a custom content package to the user from the portal service. For instance, one example of a portal service is a recommendation engine that determines characteristics of the user based on an analysis of aggregate user data and presents POIs or categories of POIs of potential interest to the user as part of delivering services via the portal. Such direction-based services can be offered as part of a cloud service as well.

While each of the various embodiments herein are presented independently, e.g., as part of the sequence of respective Figures, one can appreciate that a portable device and/or associated network services, as described, can incorporate or combine two or more of any of the embodiments. Given that each of the various embodiments improve the overall services ecosystem in which users wish to operate, together a synergy results from combining different benefits. Accordingly, the combination of different embodiments described below shall be considered herein to represent a host of further alternate embodiments.

A non-limiting device provisioned for direction based services includes an engine for analyzing location information (e.g., GPS), direction information such as compass information (e.g., North, West, South, East), and optionally movement information (e.g., accelerometer information) to allow a platform for pointing to and thereby finding objects of interest in a user's environment. A variety of scenarios are contemplated based on a user finding information of interest about objects of interests, such as restaurants, or other items around an individual, or persons, places or events of interest nearby a user and tailoring information to that user (e.g., coupons, advertisements), however at a time later than the finding. A variety of portal service implementations for facilitating the interaction are contemplated, as well as a variety of analysis functions that may be performed to enhance the portal service interaction.

Accordingly, as part of various non-limiting embodiments and example scenarios discussed in more detail below, effective ways are provided to interact with one or more of the points of interest (POIs) in connection with the provision of direction-based services. This may include marking such POIs for later interaction in connection with the provision of direction-based services, aggregating information about marked POIs, and interacting with POIs through a portal.

In this regard, sometimes an interested party, e.g., the device user and/or the publishers of content associated with a POI, will wish to delay interaction with respect to the POI or supplement a present interaction with respect to the POI with a later interaction. This could be for a variety of explicit or implicit reasons, which can be input or discerned by the device based on context. For instance, a user with limited screen space may wish to designate certain POIs for later interaction when the user can view information about the POI via a personal computer (PC) and a larger display.

For a non-limiting example scenario to demonstrate a benefit of delaying interaction, a user might pass a theater and want to go to one of the shows playing at the theater; however, the user might want to wait to reach home so she can ask her husband about availability and consult a rich Web based interface associated with the POI that clearly illustrates when the show is playing, how to buy tickets, etc. Thus, the user, with a simple designation of the POI for later interaction along with an explicit or implicit time for the future interaction, can ensure that the POI and its relevance to the user re-surface at a better time. This is in contrast to today where a user must remember to consult the web site when the user reaches home, or the user must try to figure out such information with small writing rendered by limited touch screens and input, or with limited time or network connectivity.

Moreover, the content providers, i.e., those wishing to convey information about the POI or information related to the POI, such as advertisements also benefit from the later interaction because they too can publish more content, and gather more information from the user, as well as update their content prior to publishing and also take more time to tailor the content to the user. Thus, both users and POI content providers alike benefit from the capability of users marking certain POIs for later interaction.

In another embodiment, a user marks a POI for later interaction, and additionally associates other information with the POI, e.g., in order to form lists. For instance, a user can designate a restaurant they walk by at lunch and mark it with a category such as “restaurant that I would like to try for dinner sometime.” Thus, when the user later returns to the POI through some explicit or implicit route, the user has the chance to view the list of restaurants to try for dinner. This also implicitly sets information about when the delayed interaction should occur based on context.

Delayed interaction can be defined according to a variety of different criterion, e.g., explicit user choice, a pre-set amount of time (e.g., 10 hours later), or a pre-set time (e.g., 6 pm), etc. In this regard, any criterion or combination of criteria with respect to the POI, e.g., “device comes within 2 blocks of the POI and the time is between 5 pm and 9 pm,” can be a set of criteria for notifying or reminding the user of the existence of the POI. Other information, such as device location, direction information, path information for walking to the POI can be provided as input to the delay criterion as well. In the above example, a restaurant that is not open for lunch as a user walks by, but is open for dinner, the restaurant finds a way to become relevant to the user again at a later time through the process of delayed interaction.

At any time, a user can explicitly request to view any of the POIs with which the user interacted with in the past, and this view can be with the same user device that discovered the POIs, e.g., notifications can be received at a later time or this can be with an entirely different form factor. For instance, the user can interact with the delayed set of POIs via a web site and associated storage and intelligence engine that aggregates POIs interacted with by the user, and keeps track of which POIs a user still wants to interact with, and under what delayed conditions.

Due to the nature of user desire for a POI to in effect “go away until later,” for efficient operation, a user under certain circumstances will want to quickly and easily “mark” a point of interest for later review so as to waste a minimal amount of current time and energy. Accordingly, in one embodiment, a user can carry out a unique gesture that marks POIs based on direction and motion information (e.g., accelerometer information) available on the device, such that the user can easily repeat the unique gesture to mark other objects for later review. Such unique gestures can be pre-defined for the device or pre-defined by the user. For example, with an arm, elbow and/or wrist movement(s) defining a gesture, the gesture can be used to simultaneously target and mark an object or set of objects for later interaction, e.g., via the Web.

In one embodiment, a method for using a device provisioned for pointing based services comprises receiving direction information associated with a pointed to direction of the device. Next, points of interest are identified within an area defined by the direction according to an intersection test. Next, points of interest (POIs) can be marked by the user to delay interaction with the marked POIs, e.g., to a later time when the user again interacts with the pointing based services. Thus, a way to mark POIs for later interaction is provided, or a way that sets reminders or notifications regarding the POIs to interact with them later.

For instance, one non-limiting example is a delayed typing scenario. For instance, as a user drives or walks by some real estate, a delayed typing scenario may be appropriate since the user may not have the time or enough of a keypad, or screen to learn about particular real estate of interest. For instance, typing on a mobile device might be inconvenient. Thus, via the service, a user can point at a point of interest, and with a gesture, or other input, mark the point of interest for later action. Then, when the user reaches a PC, a reminder to interact with the point of interest is present and the user can type with a full keyboard. As mentioned, information related to the delayed POIs can be transmitted to a portal service for further analysis to provide related services to the delayed POIs as well as fulfilling the delayed access.

In one embodiment, a method for using a portal service to gather additional information about POIs comprises requesting information about a set of POIs from the portal service. Next, the portal service analyzes the request, the requester, and aggregated data about POIs, and determines the set of POIs to return to the requestor. The portal service then selects at least one advertisement relating to the set of POIs to return to the requestor, and returns the advertisement and the set of POIs to the requestor.

In another embodiment, a method for providing information about POIs comprises receiving a request for a set of POIs of the direction-based services system, and identifying the profile of the requestor based on logon credentials. Next, based on the query and the profile information, analyzing aggregate interaction data representing interactions with POIs by the requestor and outputting a set of POIs of threshold relevance to the requestor.

Details of various other exemplary, non-limiting embodiments are provided below.

Portal Services Based on User Data from Direction Based Service Enabled Devices

As mentioned, one or more embodiments described herein provide the ability to identify endpoints with pointing interactions of direction based location services, and delay interaction to a more convenient moment or situation. For example, delayed editing of dynamic information about a point of interest is enabled by marking the location, and then later adding some information about the point of interest for use by the direction based services. For instance, a user does not always have time to manipulate or upload pictures, audio, automatic annotations, etc. with respect to a given point of interest at a time of creation. In such circumstances, a user can defer certain actions regarding a point of interest to a future time, e.g., create a reminder to the user as to why they wanted to add a particular point of interest for delayed interaction.

In this regard, leveraging digital compasses and location services to provide direction and location information enables a next-generation of direction or pointer based location search services, scan services, discoverability services, etc., where the digital compass and GPS can be used to point at objects of interest, thus defining the entry point for one or more data transactions between the device and one or more third party devices providing service(s) for the objects of interest at which the device is pointed. In the case of one or more embodiments described herein, a user can defer the entry point for the one or more data transactions to a later time. Using a digital compass, e.g., solid state, magnetic, sun/moon based, etc. on a mobile endpoint facilitates point and upload scenarios, point and synchronize geographical information to a Web service, cloud services or another endpoint.

As reflected in various embodiments, a device is provided that can hone in on, interact with, or otherwise transact with, a specific object or specific objects of interest by way of location and direction of the device, creating a new advertising model not previously known. As an example, when a user interacts with a particular product on a shelf at a retail store in connection with a direction based service, this creates an opportunity for anyone having an interest in the particular product to engage the user, e.g., communicate some information to that user. Any context that can be discerned from the user's actions and interactions can also be taken into account when acting on the opportunity. In the case of introducing a delay with respect to the opportunity by deferring interaction to a later time, a market is created for the future opportunity represented by the delay information, and in aggregate, can be predictive of early trends happening with products and services.

In this regard, users can interact with the endpoints in a host of context sensitive ways to provide or update information associated with endpoints of interest, or to receive beneficial information or instruments (e.g., coupons, offers, etc.) from entities associated with the endpoints of interest, and any of such actions can be deferred to a later or better time with one or more embodiments. With location services, it can be determined that a user's device is physically inside an actual store, or near a window display of a store. Coupling that to the user's interacting with an object of interest with direction information to enable direction-based services results in a new opportunity to take action based on the interaction with specific items.

In one embodiment, a portable electronic device is provided having a positional component for receiving position information as a function of a location of the portable electronic device; and at least one processor configured to process the position information to determine identifier(s) of points of interest associated with the location of the portable electronic device and based on intent information determined for the portable electronic device and the identifier(s), a set of delay criterion are set for later interaction with the given points of interest represented by the identifier(s), though for the avoidance of doubt, portal services are not limited to delayed scenarios.

As mentioned, a device can include a directional component that outputs direction information as a function of an orientation of the portable electronic device and that facilitates determining an intent of the device. The directional component can optionally be a digital compass that outputs the direction information. The device can determine a subset of items of interest relative to candidate items of interest within a 3-D space as a function of the positional information and/or the direction information.

The device can request delayed content based on a selection of an item of interest and the identifier(s). The request for the delayed content can be based on a scan of an encoding associated with an item of interest and the identifier(s). The request for delayed content can be based on a keyword received as input by the device and the identifier(s). The request for delayed content can be based on the intent information and the identifier(s) from at least one network service. The request for delayed content can also be automatic, or made by other explicit or implicit request by the user.

At a later time, and potentially from a different device, a content package can be received based on the request for the delayed content from the network service. The device can optionally include a display or sound devices, such as speakers, to display or render some or all of the graphical (e.g., text, icon, image data, video data, etc.) and/or audio content of the content package.

An initial interacting can include orientating the device toward some item(s) of interest and determining direction information associated with the orientation of the device from which a subset of the item(s) of interest are identified. For instance, interacting can include pointing the device in a direction defining a pointing line generally towards items of interest in the place(s) and determining a set of candidate items of interest as a subset of items of interest that substantially intersect with the pointing line, and enabling the selection of one or more items from the set of candidate items.

In one embodiment, a method for a device provisioned for direction based services comprises determining direction information associated with a pointed to direction relative to a pre-defined orientation of the device and identifying POIs within an area defined as a function of the pointed to direction including determining which of a set of POIs intersect with the area. Next, information corresponding to the POIs identified within the area is displayed, e.g., on a map or list, and POIs identified within the area can be interacted with at a present time or designated for a delayed interaction at a later time. In one embodiment, IDs associated with the designated POIs are transmitted to a network service enabling information about the designated POIs to be exposed at the later time, e.g., from a different form factor device. The intelligence built on top of the interactions by users with the endpoint data provides a basis for the delivery of portal services.

Interacting with POIs, or designation of POIs for later interaction, can include explicit input with respect to the designated one or more POIs, such as one or more of a gesture input, a keyword input, an audio input, a video camera input or a touchscreen input with respect to the one or more POIs. Present interactions, or the designation of POIs for later interaction can include implicit input with respect to the designated one or more POIs including making inferences about the interactions based on a context of interaction.

The displaying of POI information can be made on a topographical map visually representing at least the area defined as a function of a pointed to direction and graphical indications of the POIs can be displayed within the area at corresponding locations on the topographical map view. The POIs can also be represented in a filtered list view, e.g., filtered by restaurants in the area.

In another embodiment, a portable electronic device includes a positional component for receiving position information as a function of a location of the portable electronic device and a directional component that outputs direction information as a function of an orientation of the portable electronic device. In addition, the device includes a processor configured to process the position information and the direction information to determine identifiers or IDs of POIs within a pre-defined geographical area of the device, interact with a selected ID, receive information about the POI corresponding to the selected identifier, and receive input regarding the selected ID defining interactions.

Information about the selected ID defining the present or future interaction is transmitted along with the point of interest to a network service. In one embodiment, a pointer structure is provided on the device that visually indicates the orientation of the portable electronic device based upon which the directional component outputs the direction information. For example, this could be a triangular structure that comes to a point to show a primary orientation of the device. This could also be indicated on the display of the device during provision of direction based services.

In one embodiment, the position information and the direction information determine a pointing line and a set of candidate points of interest are determined as a subset of points of interest that substantially intersect with a function based on the pointing line. An intersection test for determining subsets of points of interest can include defining an arc based on an angle with respect to a pointing line, defining a cone based on an angle with respect to the pointing line, or a line function defining a rectangular space oriented along the pointing line (2-D or 3-D depending on the application). A speaker can render audio content if a condition upon which the future interaction is predicated occurs. The directional component can be a digital compass that outputs the direction information.

In another embodiment, a method comprises determining a place in which a portable device is located based on location information determined for the device and identifying a subset of items of interest in the place including determining an orientation of the device based on direction information of the device and determining the subset of items of interest in the place as a function of the orientation. Next, input with respect to an item of the subset of items is received as well as input defining a interaction with the item or place.

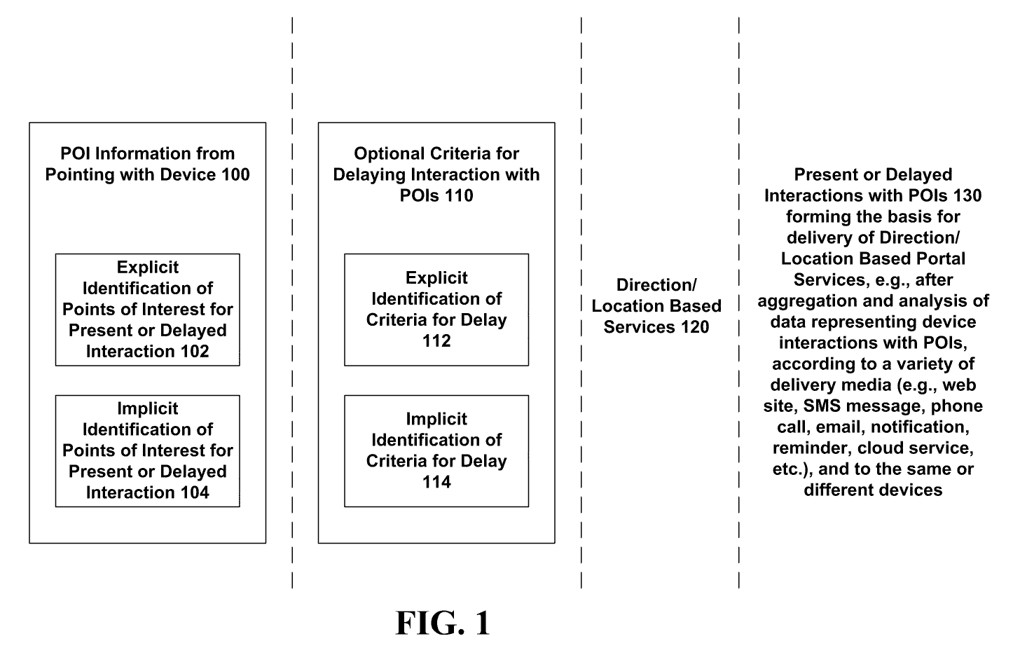

FIG. 1 is a block diagram illustrating some concepts of one or more embodiments for enabling interaction with endpoints in a direction based location system. The interaction may occur immediately or sometime later. In this regard, two main things are specified by the device participating in direction based services 120. First, the device provides POI information 100 from pointing with the device, i.e., the device identifies nearby POIs of particular interest to a user. This can be done explicitly 102 or implicitly 104. Also, the device may associate criteria for delay 110 with the POIs. This too can be done explicitly 112 or implicitly 114. Together, the POI information 100 and any delay information 110 are transmitted to direction based services 120, which enables a whole host of scenarios 130 for interaction with the POIs 100 according to the criteria 110 being satisfied. All of the data generated or exchanged during interaction with endpoints of the system become the basis for intelligent analysis and services predicated on that data from one or more portal services described herein.

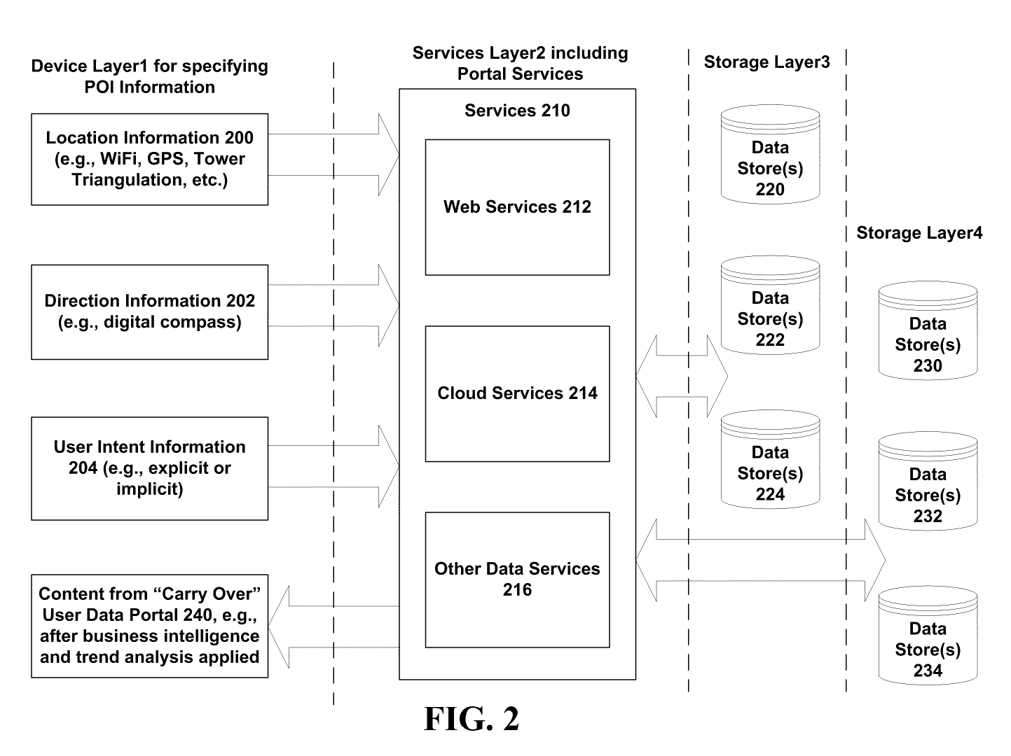

FIG. 2 is an exemplary non-limiting diagram of an architecture for achieving one or more embodiments described herein. At the device layer Layer1 for specifying delayed POI information, location information 200, direction information 202 and user intent information 204 can be input to a Layer2 with various services 210, including web services 212, cloud services 214, other data services 216, etc. Any of services 210 can have input to a set of brick and mortar store databases in Layer3, such as data store(s) 220, 222, 224, etc. or set of online or electronic retailer databases in Layer4, such as data store(s) 230, 232, 234, etc. In this regard, user intent 204 coupled with a place of the device can be utilized by one or more services 210 to retrieve and deliver custom content 240 to the device based on the intent and place of the device, e.g., now or at a later time according to a set of explicit or implicit criteria.

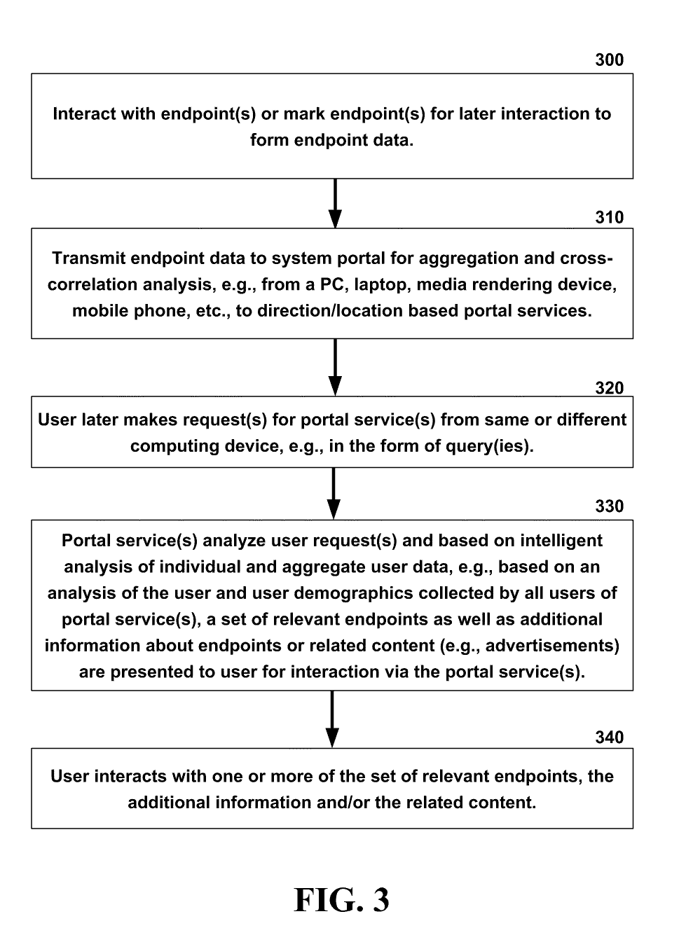

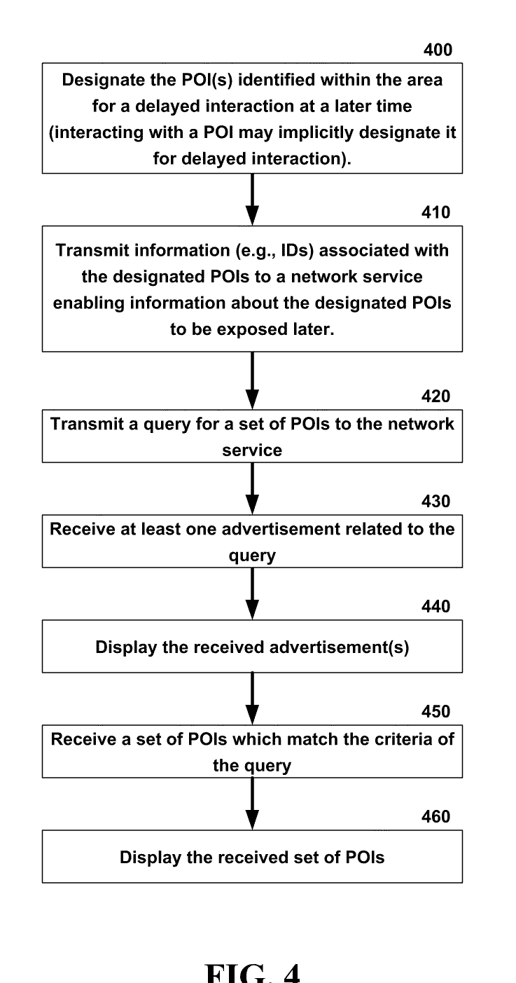

FIG. 3 is a flow diagram of a scenario where a user presently interacts with a point of interest, a user interacts with a point of interest implicitly marking it for later interaction, or explicitly marks it for later interaction, all of which interactive data can form the basis of providing one or more portal services. Examples of portal services that perform an intelligent analysis of user data includes a product recommendation engine, an advertising content delivery engine, social networking applications that exchange POI content among friends, a set of restaurant recommendations based on a set of opt in users so that you can try the restaurants eaten at by friends recently. The list of example portal services enabled by the direction based location services infrastructure described herein for one or more embodiments is limitless. Any number of intelligent applications predicated on the user interaction data can be proposed, and many of which are proposed herein.

With respect to FIG. 3, first consider the scenario where the user interacts with the POI. At 300, the user interacts with endpoint(s). At 310, the user connects to the service, and transmits endpoint data to the system portal. Other ways for triggering the interaction can be employed at 330 as described elsewhere herein. At 320, the user queries the system about marked endpoint(s). At 330, additional information related to the endpoints is received from the system. At 340, the user interacts with one or more endpoints, the additional information and/or the related content.

Alternatively, the user may wish to delay the interaction with the endpoint(s). At 300, the user either implicitly or marks explicitly endpoint(s) for later interaction or viewing. At 310, when the user connects to the service, e.g., from a PC, the user can receive reminders about marked endpoints. Other ways for triggering the interaction can be employed at 330 as described elsewhere herein. At 320, the user queries the system about marked endpoints. At 330, additional information about the endpoints is received from the system. At 340, the user interacts with one or more endpoints, the additional information and/or the related content.

FIG. 4 is a flow diagram illustrating another exemplary process for designating POIs for present or delayed interaction in connection with direction based services, the basis for data that the portal services described herein use to provide intelligent POI services. At 400, the POI(s) identified within the area are identified. This can include designating a POI for a delayed interaction at a later time. At 410, the information (e.g., ID information) associated with the POIs is transmitted to a network service enabling later interactions via the portal services. At 420, at a later time, a query for a set of POIs is transmitted to the network service via the set of portal services. At 430, based on an intelligent analysis of user data, at least one advertisement relating to the query or at least one the set of POIs that will satisfy the query is received from the network service. At 440, the advertisement(s) are displayed, and then at 450, information about a set of POIs may also optionally be received from the network service, which may be displayed at 460.

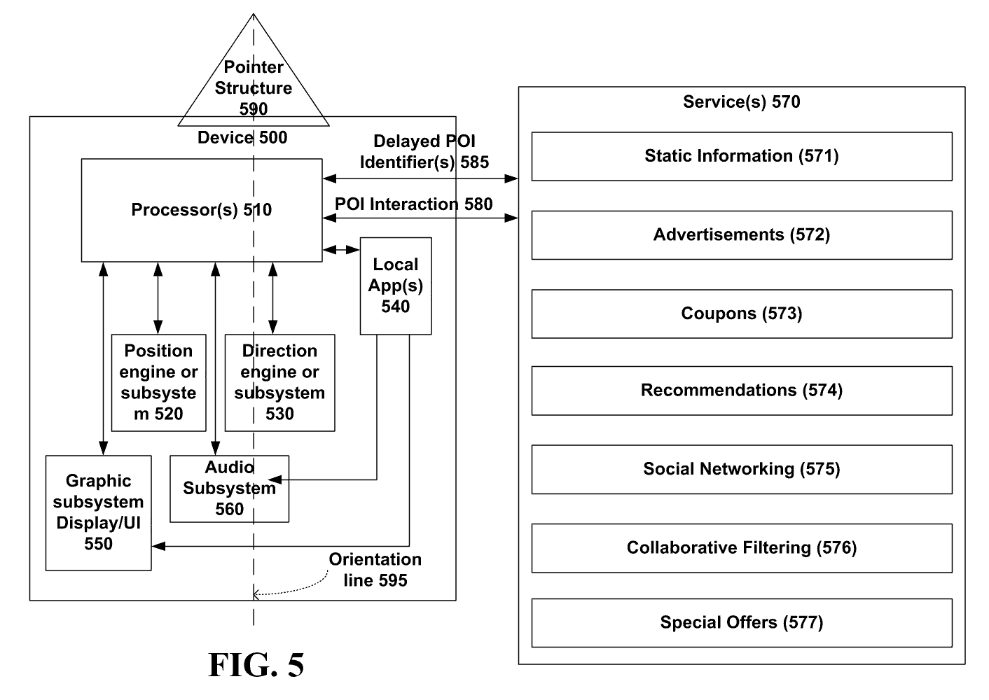

FIG. 5 illustrates an exemplary non-limiting device 500 including processor(s) 510 having a position engine or subsystem 520 for determining a location of the device 500 and a direction engine or subsystem 530 for determining a direction or orientation of the device 500. Then, by interacting with local application(s) 540 and/or service(s) 570, content can be delivered to the device, which is tailored to device intent and a place in which the device is present. The tailored content can be rendered by graphic subsystem or display/UI 550 or audio subsystem 560. In one non-limiting embodiment, point structure 590 is included, e.g., a triangular piece that points along an orientation line 595 upon which directional calculations are based. Similarly, the orientation line 595 can be indicated by graphics subsystem display/UI 550 with or without point structure 590. In this regard, various embodiments herein enable POI interaction 580 and/or delayed POI ID information 585 to and from services 570 so that the interactions can occur now or in the future as assisted by services 570. Exemplary services static information 571, advertisements 572, coupons 573, recommendations 574, social networking 575, collaborative filtering 576, and special offers 577 are shown, however, it is to be understood that any number and combination of additional services could be made available.

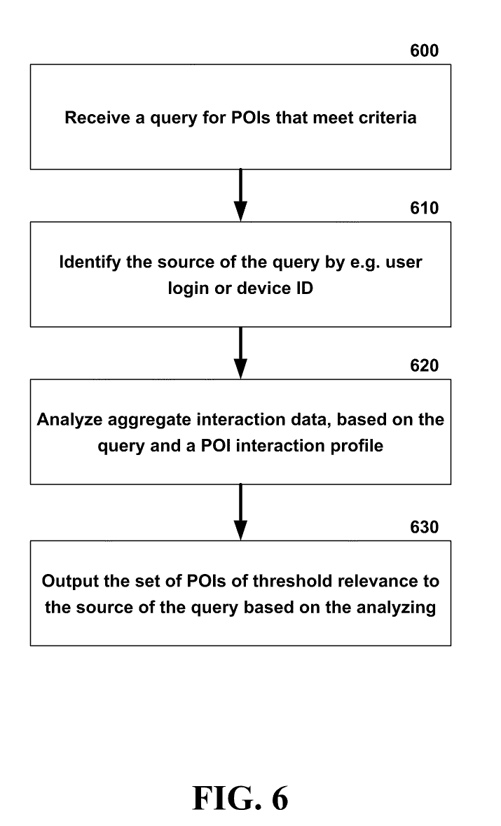

FIG. 6 is a flow diagram of a non-limiting process for facilitating interaction with points of interest. At 600, a query is received for POIs that meet a criteria. At 610, the source of the query is identified by user login data, device ID, etc. At 620, aggregate data is analyzed based on the source and criteria of the query. At 630, the set of POIs that exceed a relevance threshold are output.

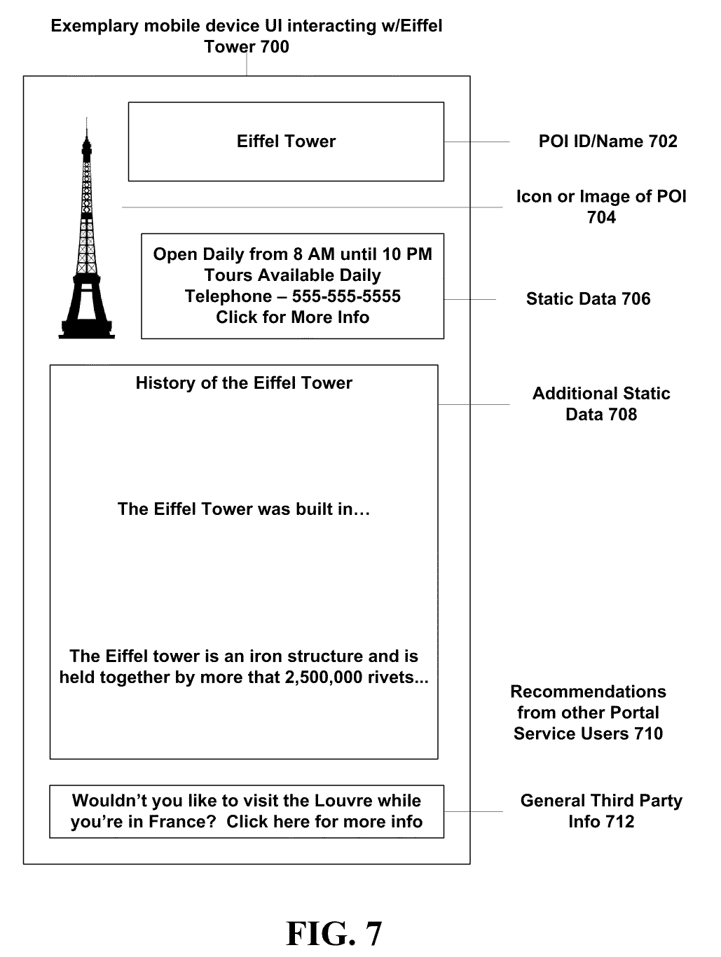

FIG. 7 is an exemplary UI for a mobile endpoint device, which has identified the Eiffel Tower as a point of interest in accordance with one or more embodiments. As a result, a portal service might offer a host of information about the nearby endpoint as part of delivering pertinent services to the user based on the user data, e.g., a user may have previously specified to the portal that the user is interested in tourist attractions when in foreign countries. The exemplary mobile device UI 700 may contain several UI elements. Examples of some UI elements include POI ID or name 702, an icon or image 704 associated with the POI, and static data 706 such as hours of operation, contact info, etc. In the current scenario, other UI elements may include additional static data 708 such as history of the POI, and general third party information 712 such as an advertisement for something in the general vicinity. Any of such displayed information may be the result of an intelligent analysis of user interaction data with POIs.

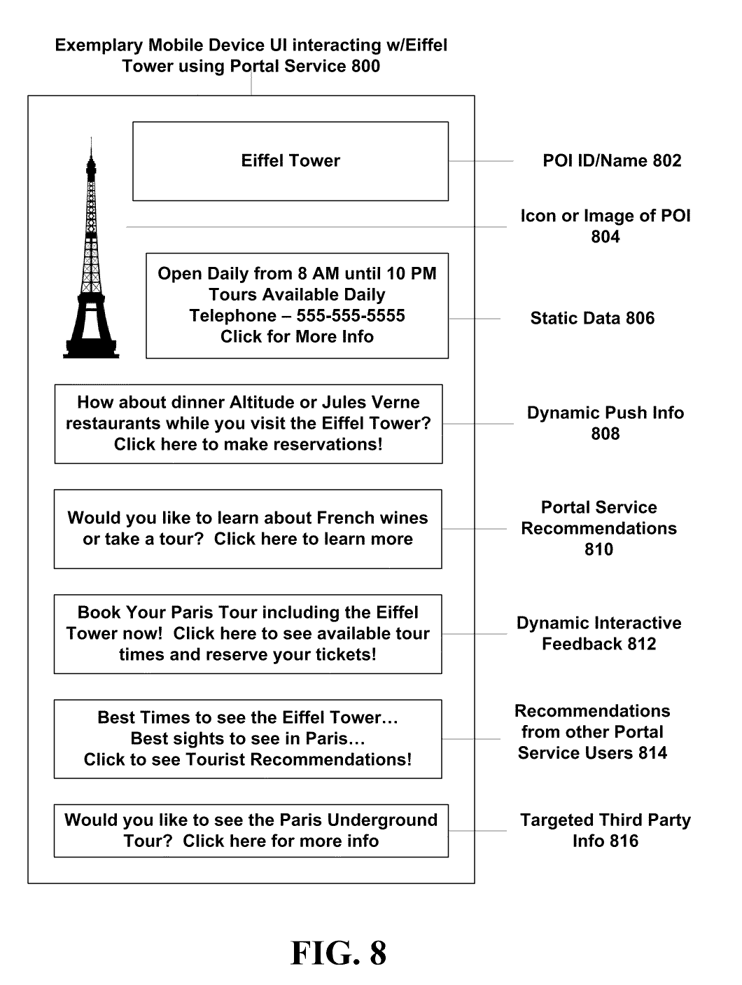

FIG. 8 is an exemplary UI for a mobile endpoint device that is interacting with the Eiffel Tower as a point of interest using the portal service in accordance with one or more embodiments. Exemplary mobile device UI 800 may contain several UI elements. These elements may include some of the same or similar elements as when the device first identified the Eiffel Tower as a POI, such as POI ID or name 802, icon or image of POI 804, and static data 806. These elements may also include UI elements which include information that is more specifically targeted at the specific user based upon prior interaction data, user profile etc. These may include dynamic push info 808 such as an offer to do more than see the POI, portal service recommendations 810 such as a suggestion of an activity available in the same area, dynamic interactive feedback 812 such as an opportunity to reserve space at the POI, and recommendations from other users of the portal service 814. The UI may also include more targeted third party information 816 such as an advertisement that is based on the user's prior underground tour experience, and the like.

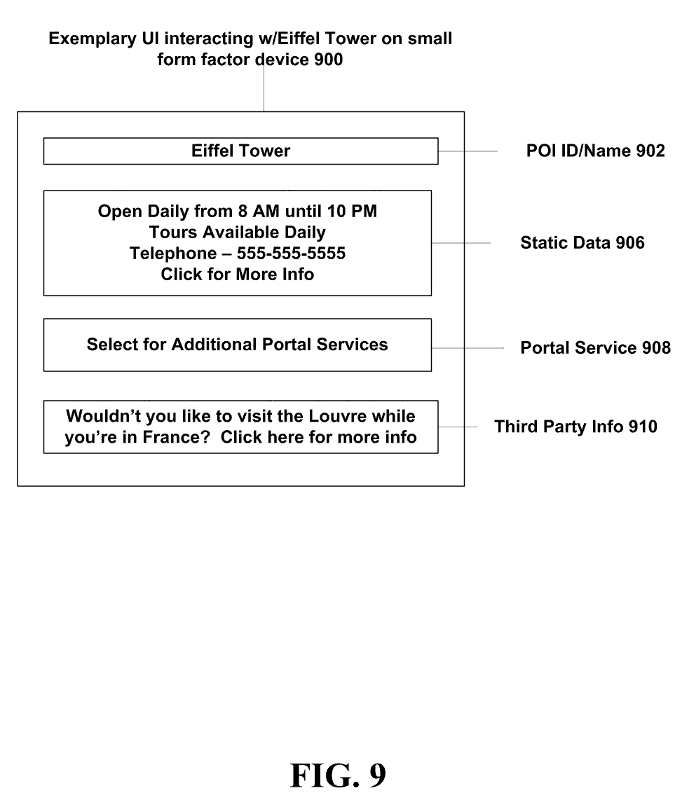

FIG. 9 is an exemplary UI for a small form factor mobile endpoint device (e.g. cell phone, PDA, etc.) which has identified the Eiffel Tower as a point of interest in accordance with one or more embodiments. Exemplary small form factor device UI 900 may include a smaller number of UI elements, such as the POI ID or name 902, the static data 906, and the third party information 910 such as an advertisement. The UI may also include an select for additional portal services 908, which may exchange some of the currently displayed information for information that is not currently displayed.

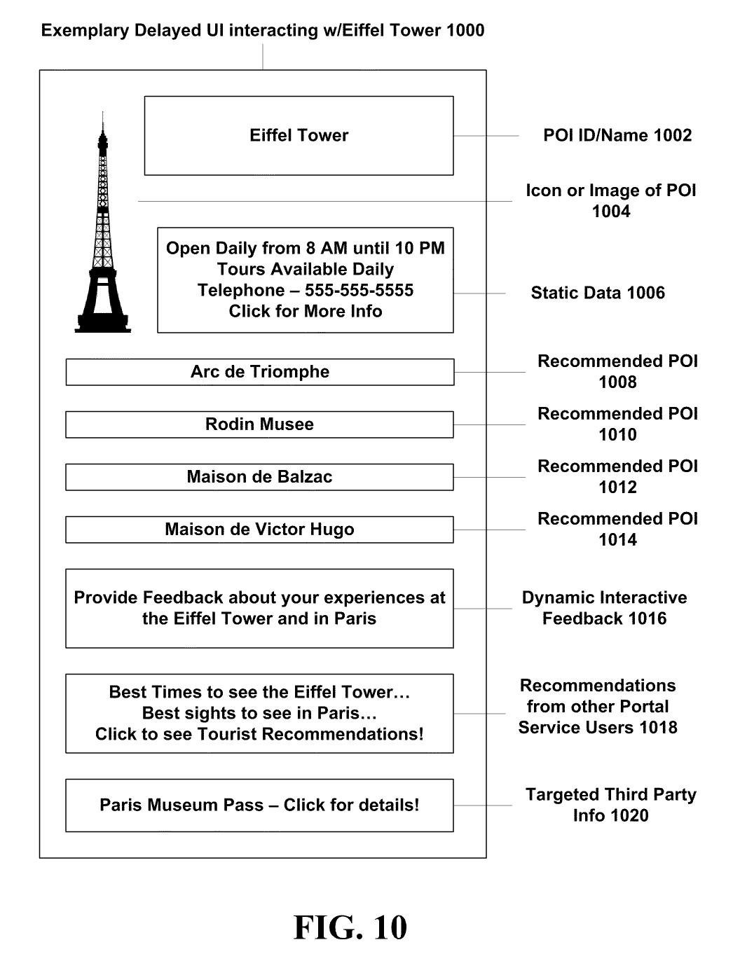

FIG. 10 is an exemplary UI for a computing device providing one or more portal services for interaction with the Eiffel Tower as a point of interest using the portal service in accordance with one or more embodiments. Exemplary UI 1000 may display many elements, which may have been chosen with more analysis of the user profile and aggregate interaction with POIs. These elements may include some of the same or similar elements as when the device first identified the Eiffel Tower as a POI, such as POI ID or name 1002, icon or image of POI 1004, and static data 1006. Additional elements may include a set of recommended POIs 1008, 1010, 1012, 1014 based on an analysis of the user's past POI interaction with a specific type of POI (e.g., museums), and continuing presence in Paris. The portal service may solicit feedback on the current POI 1016 to provide updated data to users of the service. The portal service may offer recommendations from other users of the service. The third party info 1020 may be specifically targeted to align with the user's known interest in a specific type of POI (e.g., museums).

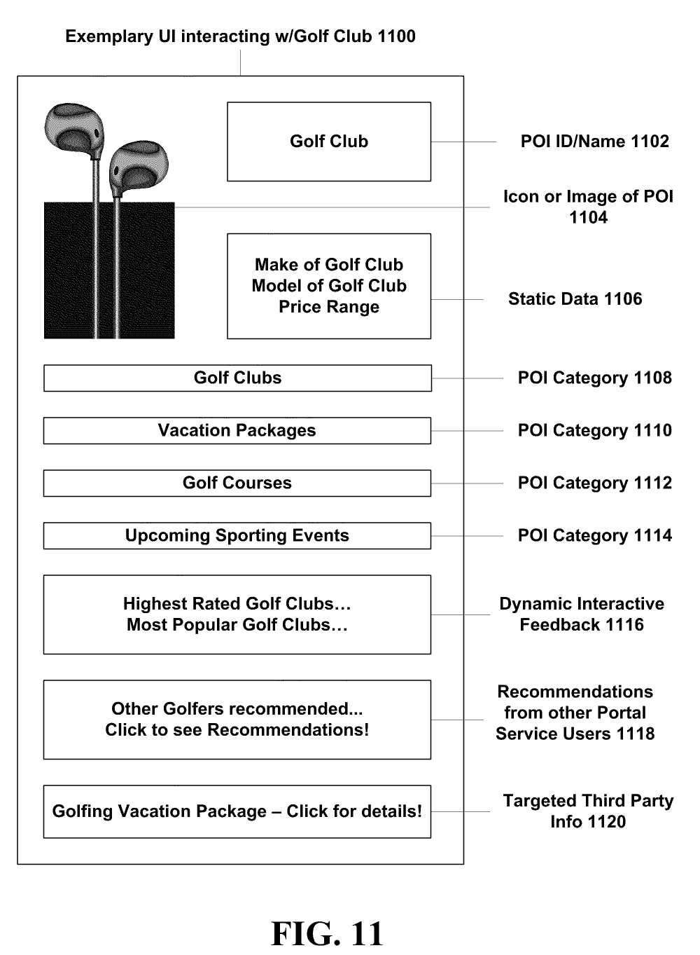

FIG. 11 is an exemplary UI for a computing device that is interacting with a golf club via portal service(s), e.g., a portal service that has learned of the user's interest in golf based on related demographic information discovered via interactions with POIs in direction based services system. Exemplary UI 1100 of the portal service may include a variety of UI elements, such as a POI ID or name 1102, an icon or image 1104 representing the POI, static data 1106 about the POI. The portal service may perform some analysis based on the profile of the user, the presently selected POI, aggregate data about this type of POI and those who most typically interact with it, etc. The UI may then display categories of likely interest to the user 1108, 1110, 1112, and 1114. The UI may display elements for providing information to the user such as dynamic interactive feedback 1116, recommendations from other portal service users 1118, etc. The UI may also display targeted third party information 1120 such as an advertisement targeted based on the analysis of the user profile, POI, etc.

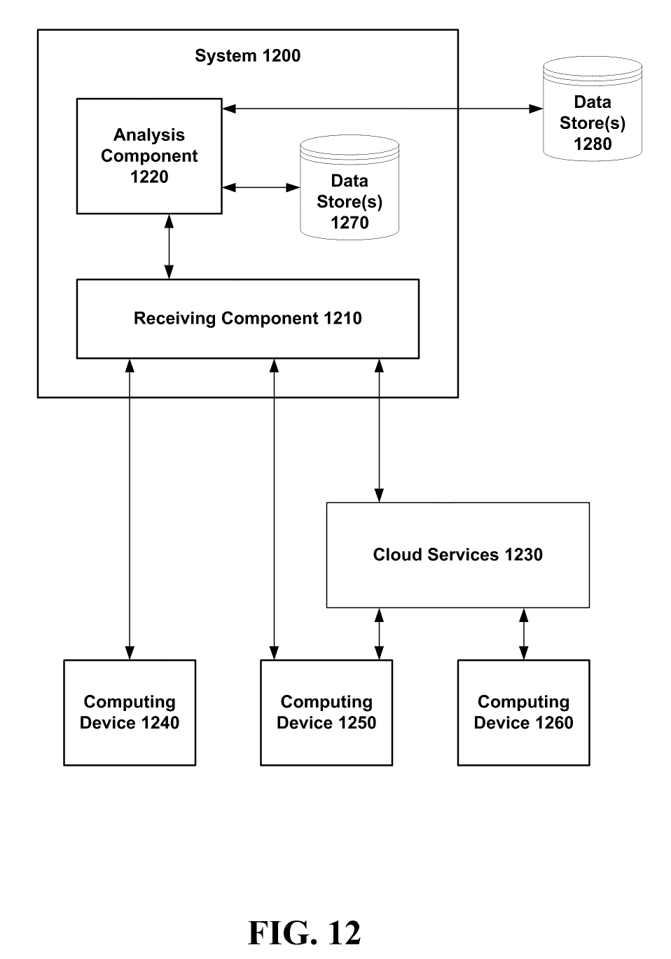

FIG. 12 is a block diagram of an exemplary architecture for a system that supports interaction with points of interest that may utilize cloud services in accordance with one or more embodiments. System 1200 comprises a receiving component 1210 for receiving query criteria and other information, and an analysis component 1220 for analyzing the query criteria, other received information, as well as data stored in local data store(s) 1270 and remote data store(s) 1280. Cloud services 1230 receives queries from computing devices 1250, 1260 and passes the queries to receiving component 1210. Computing device 1240 queries the system directly, while computing device 1260 queries the system using the cloud services 1230 only. Computing device 1250 may use the cloud services 1230 or query the system 1200 directly using receiving component 1210.

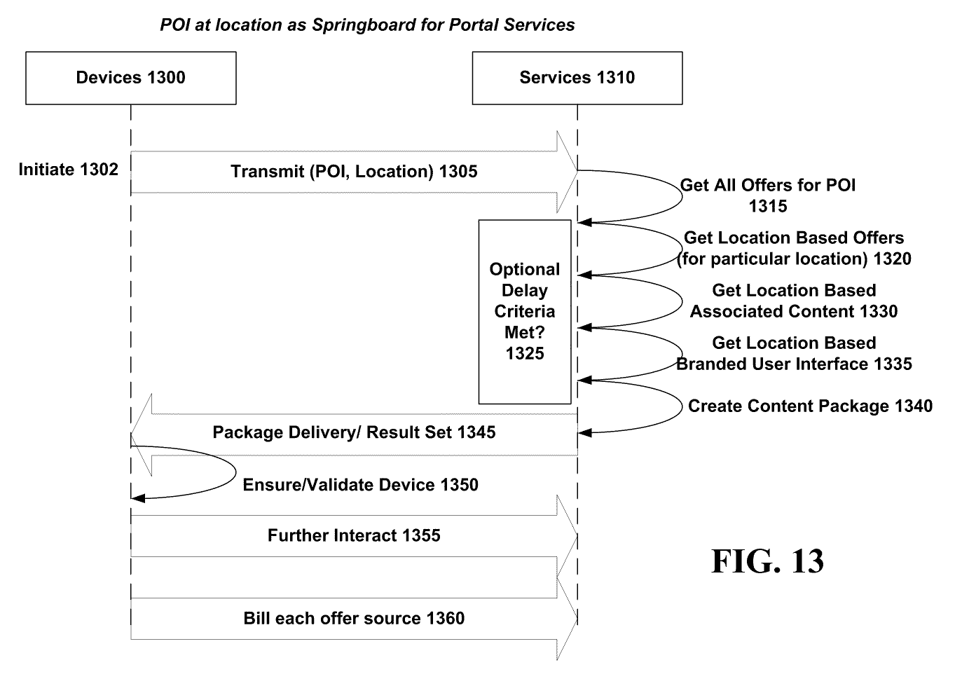

FIG. 13 is a block diagram illustrating an exemplary non-limiting exchange between a device 1300 and service 13 10. After start 1302, an example request for illustrative purpose is made by a device 1300 to a service 1310, which includes data related to the location of the device, and a given POI. For instance, then, at 1315, the service 1310 gets all offers for the POI 1315 and/or at 1320, gets the offers for the given location. The service 1310 may get updated content associated with the location 1330 along with an optional branded user interface at 1335. At 1340, an updated content package is created and delivered to the device 1300 at 1345. The device can undergo a check for the device at 1350.The interaction can take place at 1355. Optionally, based on an advertising model, the content providers or owners can be billed at 1360. In the instance where this is a delayed interaction, there may be delay criteria, and the services 1310 may wait until the delay criteria 1325 are met before performing some or all of these functions.

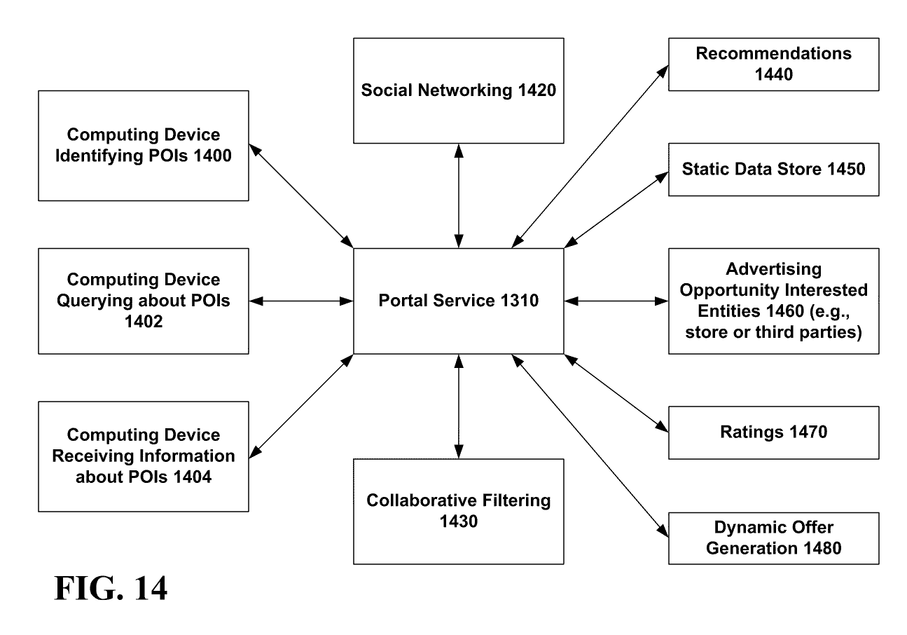

FIG. 14 is a block diagram illustrating a non-limiting example of an architecture including a portal service for interacting with points of interest. Computing devices 1400, 1402, 1404 perform various interactions with the portal service 1410 such as identifying POIs, querying about POIs, and receiving information about POIs. Portal service 1410 interacts with many additional services to provide a rich set of information about the POIs to the computing devices. In addition, portal service 1410 provides additional information to many additional services to enhance future interactions. Some examples of the additional services are social networking 1420, which may be used to allow users of the portal to connect socially, collaborative filtering 1430, which may allow recommendations of POIs not identified but potentially interesting, recommendations 1440, which may allow simple recommendations to be displayed. More examples are static data store 1450, which may provide certain information about a POI (e.g. hours of operation, menu, etc.), advertising opportunity interested entities 1460, which may serve advertisements, ratings 1470, which may show ratings for a POI, e.g. by a rating service, as opposed to by another user.

Another example is dynamic offer generation 1480, which may generate a dynamic offer for a specific entity, based on the profile of the entity and the interest in a given POI. In an exemplary embodiment, when computing device 1400 representing a certain profile (e.g., the user dines out frequently and carries a credit card with a high limit) marks a given POI, an offer to entice the user into the POI may be generated and sent to the computing device 1400 by dynamic offer generation 1480. In an alternative embodiment, when a POI is experiencing a slow time of business, it may use dynamic offer generation 1480 to make offers to a number of computing devices 1400, 1402, 1404 in a proximity to the POI, or for a certain amount of time, or until business picks up, etc.

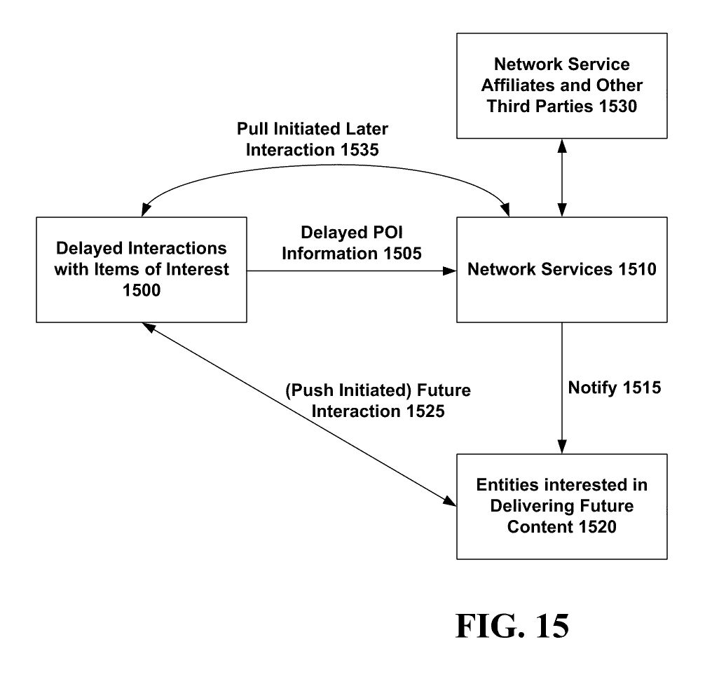

FIG. 15 illustrates at a high level, via a block diagram, a beneficial advertising model enabled by a direction/location based services with delayed interaction with endpoints as described in one or more embodiments herein. For instance, scanned items 1500 for delay, or pointed to items 1500 for delay, or any other action taken with respect to items 1500 for delay can be sent as information 1505 to a service 1510 that brokers interested third parties 1520 or 1530 who wish to advertise given the place and particular items 1500. Accordingly, such third parties 1520 or 1530 (third parties may be misleading because third parties can include parties related to a retail establishment where the device is currently located) can provide content as part of interactions 1525 or 1535 as part of a push or pull experience from the user perspective. This opportunity to provide content in a delayed manner enables services 1510 to notify 1515 parties 1520 interested in the delayed interaction. This beneficial information provided to third parties 1520 or 1530 about potential delayed interactions with particular POIs and places is therefore an opportunity to monetize the transaction back to those who benefit from a resulting transaction or advertising opportunity.

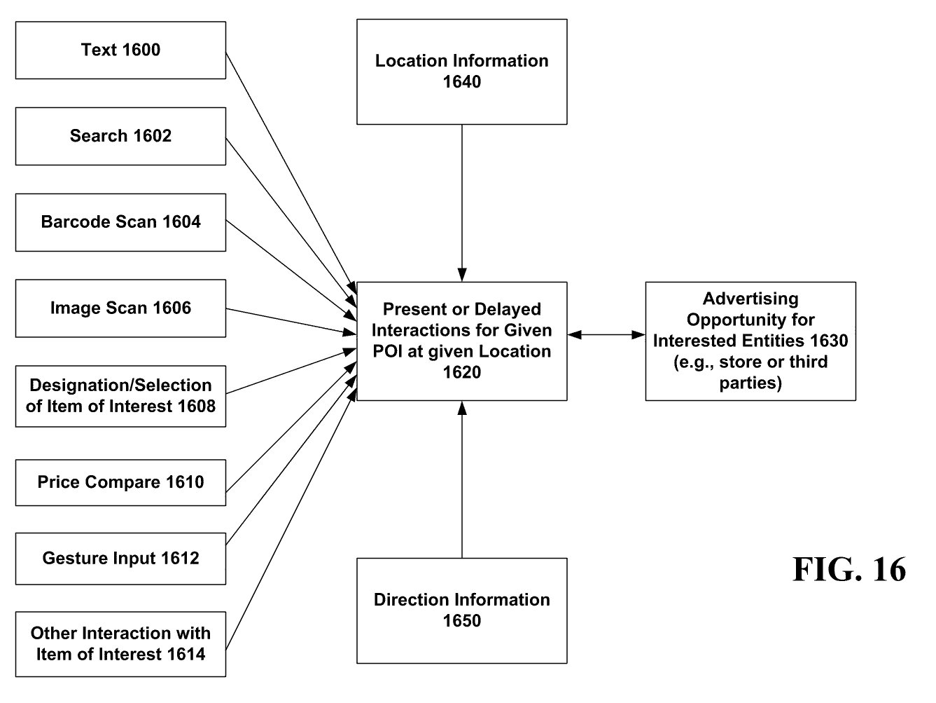

FIG. 16 is a block diagram illustrating a vast wealth of actions and interactions that can help define intent/context 1620 to delay for a given POI and location at which the device is present. For instance, text 1600 may be received by the device, a product search query 1602 local to the store, bar code scan 1604, image scan 1606, explicit designation of a product (e.g., by pointing at a product, or taking an image of the product and performing image recognition) 1608, price compare request 1610, gesture input 1612, other interaction 1614, etc. can all be taken into account in discerning intent of the device at a given place, along with direction information 1650. This combined with location information 1640 for discerning the place in which the device is in results in advertising opportunities 1630 for a whole host of third party advertising transactions for delayed delivery to the device.

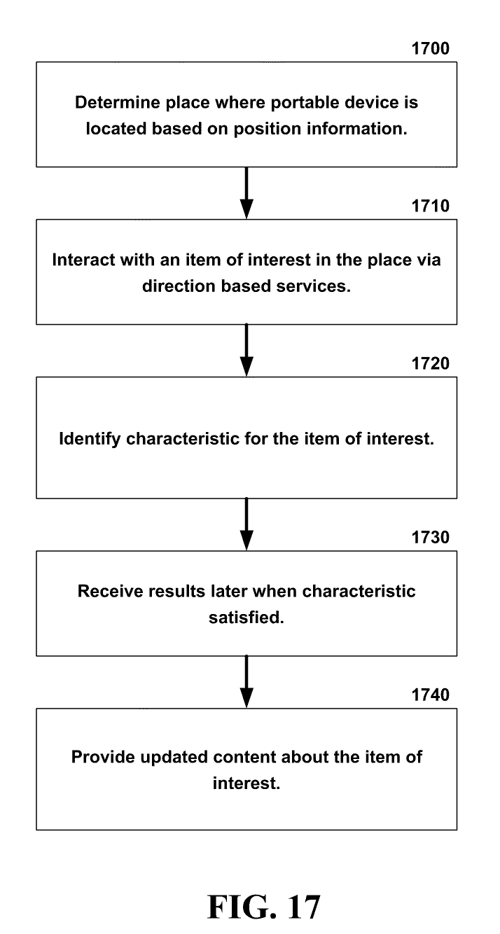

FIG. 17 is a flow diagram of an exemplary non-limiting process for using a device and services as described herein. At 1700, a place where a portable device is located is determined based on position information. At 1710, the device interacts with an item of interest in the place via direction based services. At 1720, a desired characteristic for the item of interest is indicated. At 1730, results regarding the item of interest are received later when the characteristic is satisfied. At 1740, updated content about the item of interest can be provided.

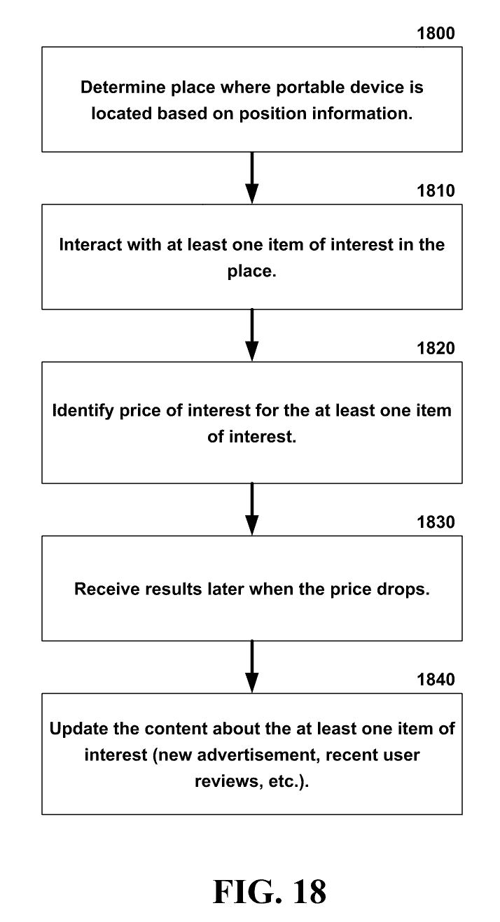

FIG. 18 is a flow diagram of a non-limiting scenario for the process of FIG. 17. At 1800, a place where the portable device is located is determined based on position information. At 1810, the device interacts with an item of interest in the place via direction based location services as described elsewhere herein. At 1820, the user identifies a target price for the item of interest. At 1830, results respecting the item of interest are delivered later when the price drops, e.g., 2 months later. At 1840, the content about the item of interest can be updated on an ongoing basis or at the time of delivery of the delayed content (e.g., new or updated advertisement, recent user reviews, etc.).

### Supplemental Context Regarding Pointing Devices, Architectures and Services

The following description contains supplemental context regarding potential non-limiting pointing devices, architectures and associated services to further aid in understanding one or more of the above embodiments. Any one or more of any additional features described in this section can be accommodated in any one or more of the embodiments described above with respect to delayed direction based services at a particular location for given POI(s). While such combinations of embodiments or features are possible, for the avoidance of doubt, no embodiments set forth in the subject disclosure should be considered limiting on any other embodiments described herein.

As mentioned, a broad range of scenarios can be enabled by a device that can take location and direction information about the device and build a service on top of that information. For example, by using an accelerometer in coordination with an on board digital compass, an application running on a mobile device updates what each endpoint is “looking at” or pointed towards, attempting hit detection on potential points of interest to either produce real-time information for the device or to allow the user to select a range, or using the GPS, a location on a map, and set information such as “Starbucks—10% off cappuccinos today” or “The Alamo—site of . . . ” for others to discover. One or more accelerometers can also be used to perform the function of determining direction information for each endpoint as well. As described herein, these techniques can become more granular to particular items within a Starbucks, such as “blueberry cheesecake” on display in the counter, enabling a new type of sale opportunity.

Accordingly, a general device for accomplishing this includes a processing engine to resolve a line of sight vector sent from a mobile endpoint and a system to aggregate that data as a platform, enabling a host of new scenarios predicated on the pointing information known for the device. The act of pointing with a device, such as the user's mobile phone, thus becomes a powerful vehicle for users to discover and interact with points of interest around the individual in a way that is tailored for the individual. Synchronization of data can also be performed to facilitate roaming and sharing of POV data and contacts among different users of the same service.

In a variety of embodiments described herein, 2-dimensional (2D), 3-dimensional (3D) or N-dimensional directional-based search, discovery, and interactivity services are enabled for endpoints in the system of potential interest to the user.

The pointing information and corresponding algorithms depend upon the assets available in a device for producing the pointing or directional information. The pointing information, however produced according to an underlying set of measurement components, and interpreted by a processing engine, can be one or more vectors. A vector or set of vectors can have a “width” or “arc” associated with the vector for any margin of error associated with the pointing of the device. A panning angle can be defined by a user with at least two pointing actions to encompass a set of points of interest, e.g., those that span a certain angle defined by a panning gesture by the user.

In one non-limiting embodiment, a portable electronic device includes a positional component for receiving positional information as a function of a location of the portable electronic device, a directional component that outputs direction information as a function of an orientation of the portable electronic device and a location based engine that processes the positional information and the direction information to determine a subset of points of interest relative to the portable electronic device as a function of at least the positional information and the direction information.

The positional component can be a positional GPS component for receiving GPS data as the positional information. The directional component can be a magnetic compass and/or a gyroscopic compass that outputs the direction information. The device can include acceleration component(s), such as accelerometer(s), that outputs acceleration information associated with movement of the portable electronic device. The use of a separate sensor can also be used to further compensate for tilt and altitude adjustment calculations.

In one embodiment, the device includes a cache memory for dynamically storing a subset of endpoints of interest that are relevant to the portable electronic device and at least one interface to a network service for transmitting the positional information and the direction information to the network service. In return, based on real-time changes to the positional information and direction/pointing information, the device dynamically receives in the cache memory an updated subset of endpoints that are potentially relevant to the portable electronic device.

For instance, the subset of endpoints can be updated as a function of endpoints of interest within a pre-defined distance substantially along a vector defined by the orientation of the portable electronic device. Alternatively or in addition, the subset of endpoints can be updated as a function of endpoints of interest relevant to a current context of the portable electronic device. In this regard, the device can include a set of Representational State Transfer (REST)-based application programming interfaces (APIs), or other stateless set of APIs, so that the device can communicate with the service over different networks, e.g., Wi-Fi, a GPRS network, etc. or communicate with other users of the service, e.g., Bluetooth. For the avoidance of doubt, the embodiments are in no way limited to a REST based implementation, but rather any other state or stateful protocol could be used to obtain information from the service to the devices.

The directional component outputs direction information including compass information based on calibrated and compensated heading/directionality information. The directional component can also include direction information indicating upward or downward tilt information associated with a current upward or downward tilt of the portable electronic device, so that the services can detect when a user is pointing upwards or downwards with the device in addition to a certain direction. The height of the vectors itself can also be taken into account to distinguish between an event of pointing with a device from the top of a building (likely pointing to other buildings, bridges, landmarks, etc.) and the same event from the bottom of the building (likely pointing to a shop at ground level), or towards a ceiling or floor to differentiate among shelves in a supermarket. A 3-axis magnetic field sensor can also be used to implement a compass to obtain tilt readings.

Secondary sensors, such as altimeters or pressure readers, can also be included in a mobile device and used to detect a height of the device, e.g., what floor a device is on in a parking lot or floor of a department store (changing the associated map/floorplan data). Where a device includes a compass with a planar view of the world (e.g., 2-axis compass), the inclusion of one or more accelerometers in the device can be used to supplement the motion vector measured for a device as a virtual third component of the motion vector, e.g., to provide measurements regarding a third degree of freedom. This option may be deployed where the provision of a 3-axis compass is too expensive, or otherwise unavailable.

In this respect, a gesturing component can also be included in the device to determine a current gesture of a user of the portable electronic device from a set of pre-defined gestures. For example, gestures can include zoom in, zoom out, panning to define an arc, all to help filter over potential subsets of points of interest for the user.

For instance, web services can effectively resolve vector coordinates sent from mobile endpoints into <x,y,z> or other coordinates using location data, such as GPS data, as well as configurable, synchronized POV information similar to that found in a GPS system in an automobile. In this regard, any of the embodiments can be applied similarly in any motor vehicle device. One non-limiting use is also facilitation of endpoint discovery for synchronization of data of interest to or from the user from or to the endpoint.

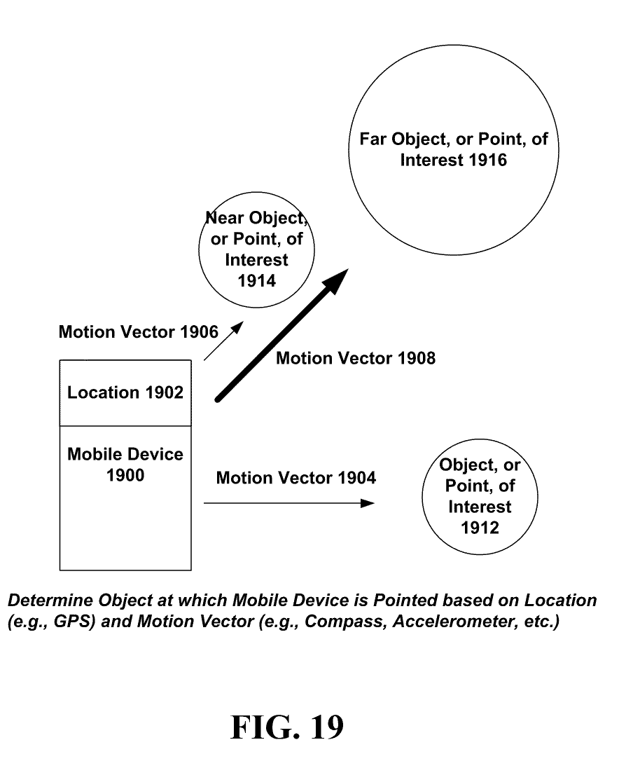

Among other algorithms for interpreting position/motion/direction information, as shown in FIG. 19, a device 1900 employing the direction based location based services 1902 as described herein in a variety of embodiments herein include a way to discern between near objects, such as POI 1914 and far objects, such as POI 1916. Depending on the context of usage, the time, the user's past, the device state, the speed of the device, the nature of the POIs, etc., the service can determine a general distance associated with a motion vector. Thus, a motion vector 1906 will implicate POI 1914, but not POI 1916, and the opposite would be true for motion vector 1908.

In addition, a device 1900 includes an algorithm for discerning items substantially along a direction at which the device is pointing, and those not substantially along a direction at which the device is pointing. In this respect, while motion vector 1904 might implicate POI 1912, without a specific panning gesture that encompassed more directions/vectors, POIs 1914 and 1916 would likely not be within the scope of points of interest defined by motion vector 1904. The distance or reach of a vector can also be tuned by a user, e.g., via a slider control or other control, to quickly expand or contract the scope of endpoints encompassed by a given “pointing” interaction with the device.

In one non-limiting embodiment, the determination of at what or whom the user is pointing is performed by calculating an absolute “Look” vector, within a suitable margin of error, by a reading from an accelerometer's tilt and a reading from the magnetic compass. Then, an intersection of endpoints determines an initial scope, which can be further refined depending on the particular service employed, i.e., any additional filter. For instance, for an apartment search service, endpoints falling within the look vector that are not apartments ready for lease, can be pre-filtered.

In addition to the look vector determination, the engine can also compensate for, or begin the look vector, where the user is by establish positioning (˜15 feet) through an A-GPS stack (or other location based or GPS subsystem including those with assistance strategies) and also compensate for any significant movement/acceleration of the device, where such information is available.

As mentioned, in another aspect, a device can include a client side cache of potentially relevant points of interest, which, based on the user's movement history can be dynamically updated. The context, such as geography, speed, etc. of the user can be factored in when updating. For instance, if a user's velocity is 2 miles an hour, the user may be walking and interested in updates at a city block by city block level, or at a lower level granularity if they are walking in the countryside. Similarly, if a user is moving on a highway at 60 miles per hour, the block-by-block updates of information are no longer desirable, but rather a granularity can be provided and predictively cached on the device that makes sense for the speed of the vehicle.

In an automobile context, the location becomes the road on which the automobile is travelling, and the particular items are the places and things that are passed on the roadside much like products in a particular retail store on a shelf or in a display. The pointing based services thus creates a virtual “billboard” opportunity for items of interest generally along a user's automobile path. Proximity to location can lead to an impulse buy, e.g., a user might stop by a museum they are passing and pointing at with their device, if offered a discount on admission.

In various alternative embodiments, gyroscopic or magnetic compasses can provide directional information. A REST based architecture enables data communications to occur over different networks, such as Wi-Fi and GPRS architectures. REST based APIs can be used, though any stateless messaging can be used that does not require a long keep alive for communicated data/messages. This way, since networks can go down with GPRS antennae, seamless switching can occur to Wi-Fi or Bluetooth networks to continue according to the pointing based services enabled by the embodiments described herein.

A device as provided herein according to one or more embodiments can include a file system to interact with a local cache, store updates for synchronization to the service, exchange information by Bluetooth with other users of the service, etc. Accordingly, operating from a local cache, at least the data in the local cache is still relevant at a time of disconnection, and thus, the user can still interact with the data. Finally, the device can synchronize according to any updates made at a time of re-connection to a network, or to another device that has more up to date GPS data, POI data, etc. In this regard, a switching architecture can be adopted for the device to perform a quick transition from connectivity from one networked system (e.g., cell phone towers) to another computer network (e.g., Wi-Fi) to a local network (e.g., mesh network of Bluetooth connected devices).

With respect to user input, a set of soft keys, touch keys, etc. can be provided to facilitate in the directional-based pointing services provided herein. A device can include a windowing stack in order to overlay different windows, or provide different windows of information regarding a point of interest (e.g., hours and phone number window versus interactive customer feedback window). Audio can be rendered or handled as input by the device. For instance, voice input can be handled by the service to explicitly point without the need for a physical movement of the device. For instance, a user could say into a device “what is this product right in front of me? No, not that one, the one above it” and have the device transmit current direction/movement information to a service, which in turn intelligently, or iteratively, determines what particular item of interest the user is pointing at, and returns a host of relevant information about the item.

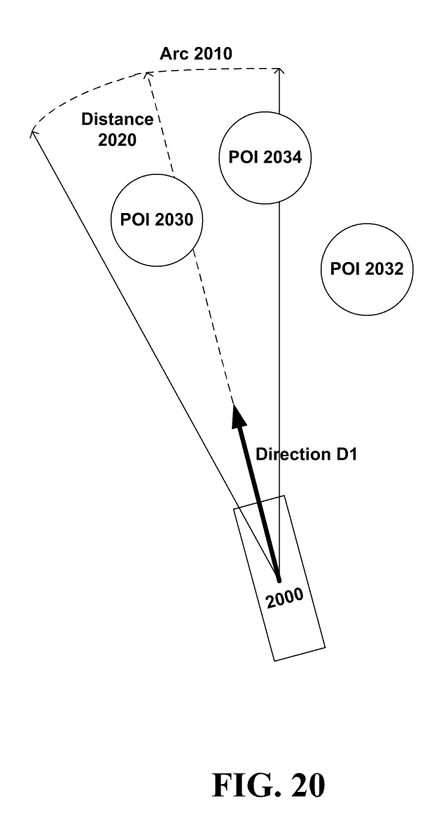

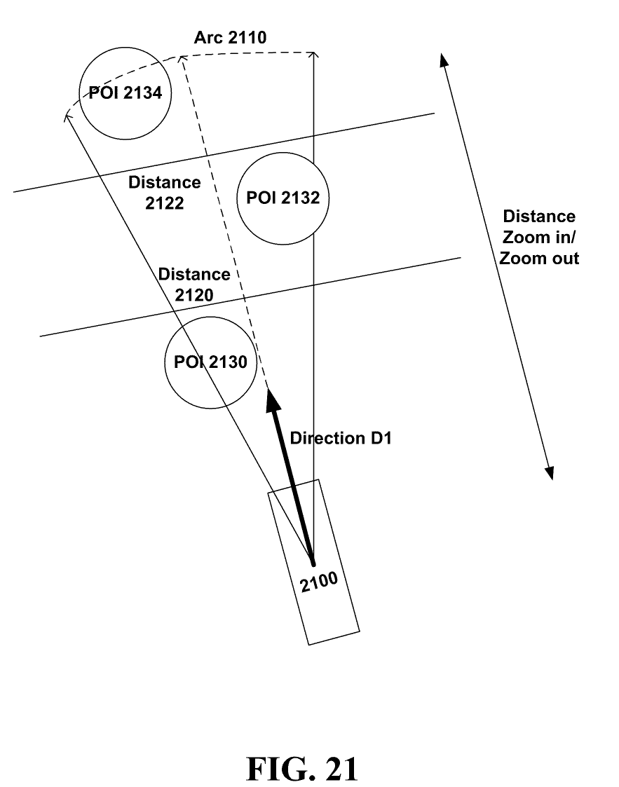

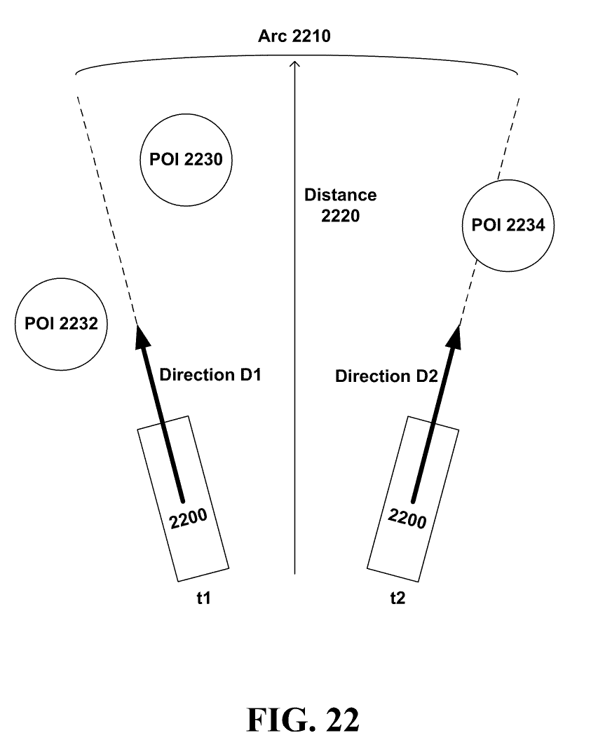

One non-limiting way for determining a set of points of interest is illustrated in FIG. 20. In FIG. 20, a device 2000 is pointed (e.g., point and click) in a direction D1, which according to the device or service parameters, implicitly defines an area within arc 2010 and distance 2020 that encompasses POI 2030, but does not encompass POI 2032. Such an algorithm will also need to determine any edge case POIs, i.e., whether POIs such as POI 2034 are within the scope of pointing in direction D1, where the POI only partially falls within the area defined by arc 2010 and distance 2020.

Other gestures that can be of interest in for a gesturing subsystem include recognizing a user's gesture for zoom in or zoom out. Zoom in/zoom out can be done in terms of distance like FIG. 21. In FIG. 21, a device 2100 pointed in direction D1 may include zoomed in view which includes points of interest within distance 2120 and arc 2110, or a medium zoomed view representing points of interest between distance 2120 and 2122, or a zoomed out view representing points of interest beyond distance 2122. These zoom zones correspond to POIs 2130, 2132 and 2134, respectively. More or less zones can be considered depending upon a variety of factors, the service, user preference, etc.

For another non-limiting example, with location information and direction information, a user can input a first direction via a click, and then a second direction after moving the device via a second click, which in effect defines an arc 2210 for objects of interest in the system as illustrated in FIG. 22. For instance, via first pointing act by the user at time t1 in direction D1 and a second pointing act at time t2 by the user in direction D2, an arc 2210 is implicitly defined. The area of interest implicitly includes a search of points of object within a distance 2220, which can be zoomed in and out, or selected by the service based on a known granularity of interest, selected by the user, etc. This can be accomplished with a variety of forms of input to define the two directions. For instance, the first direction can be defined upon a click-and-hold button event, or other engage-and-hold user interface element, and the second direction can be defined upon release of the button. Similarly, two consecutive clicks corresponding to the two different directions D1 and D2 can also be implemented.

Also, instead of focusing on real distance, zooming in or out could also represent a change in terms of granularity, or size, or hierarchy of objects. For example, a first pointing gesture with the device may result in a shopping mall appearing, but with another gesture, a user could carry out a recognizable gesture to gain or lose a level of hierarchical granularity with the points of interest on display. For instance, after such gesture, the points of interest could be zoomed in to the level of the stores at the shopping mall and what they are currently offering.

In addition, a variety of even richer behaviors and gestures can be recognized when acceleration of the device in various axes can be discerned. Panning, arm extension/retraction, swirling of the device, backhand tennis swings, breaststroke arm action, golf swing motions could all signify something unique in terms of the behavior of the pointing device, and this is to just name a few motions that could be implemented in practice. Thus, any of the embodiments herein can define a set of gestures that serve to help the user interact with a set of services built on the pointing platform, to help users easily gain information about points of information in their environment.

Furthermore, with relatively accurate upward and downward tilt of the device, in addition to directional information such as calibrated and compensated heading/directional information, other services can be enabled. Typically, if a device is ground level, the user is outside, and the device is “pointed” up towards the top of buildings, the granularity of information about points of interest sought by the user (building level) is different than if the user was pointing at the first floor shops of the building (shops level), even where the same compass direction is implicated. Similarly, where a user is at the top of a landmark such as the Empire State building, a downward tilt at the street level (street level granularity) would implicate information about different points of interest that if the user of the device pointed with relatively no tilt at the Statue of Liberty (landmark/building level of granularity).

Also, when a device is moving in a car, it may appear that direction is changing as the user maintains a pointing action on a single location, but the user is still pointing at the same thing due to displacement. Thus, thus time varying location can be factored into the mathematics and engine of resolving at what the user is pointing with the device to compensate for the user experience based upon which all items are relative.

Accordingly, armed with the device's position, one or more web or cloud services can analyze the vector information to determine at what or whom the user is looking/pointing. The service can then provide additional information such as ads, specials, updates, menus, happy hour choices, etc., depending on the endpoint selected, the context of the service, the location (urban or rural), the time (night or day), etc. As a result, instead of a blank contextless Internet search, a form of real-time visual search for users in real 3-D environments is provided.

In one non-limiting embodiment, the direction based pointing services are implemented in connection with a pair of glasses, headband, etc. having a corresponding display means that acts in concert with the user's looking to highlight or overlay features of interest around the user.

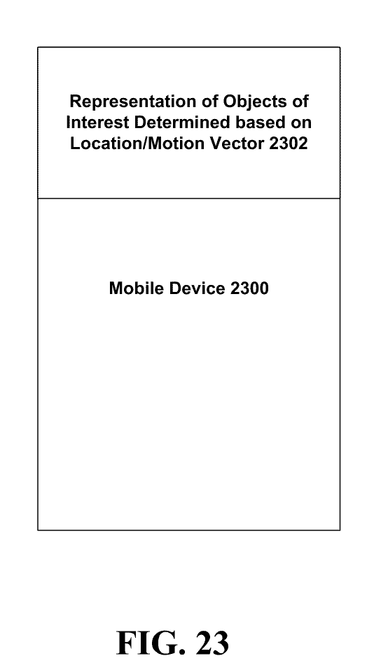

As shown in FIG. 23, once a set of objects is determined from the pointing information according to a variety of contexts of a variety of services, a mobile device 2300 can display the objects via representation 2302 according to a variety of user experiences tailored to the service at issue. For instance, a virtual camera experience can be provided, where POI graphics or information can be positioned relative to one another to simulate an imaging experience. A variety of other user interface experiences can be provided based on the pointing direction as well.

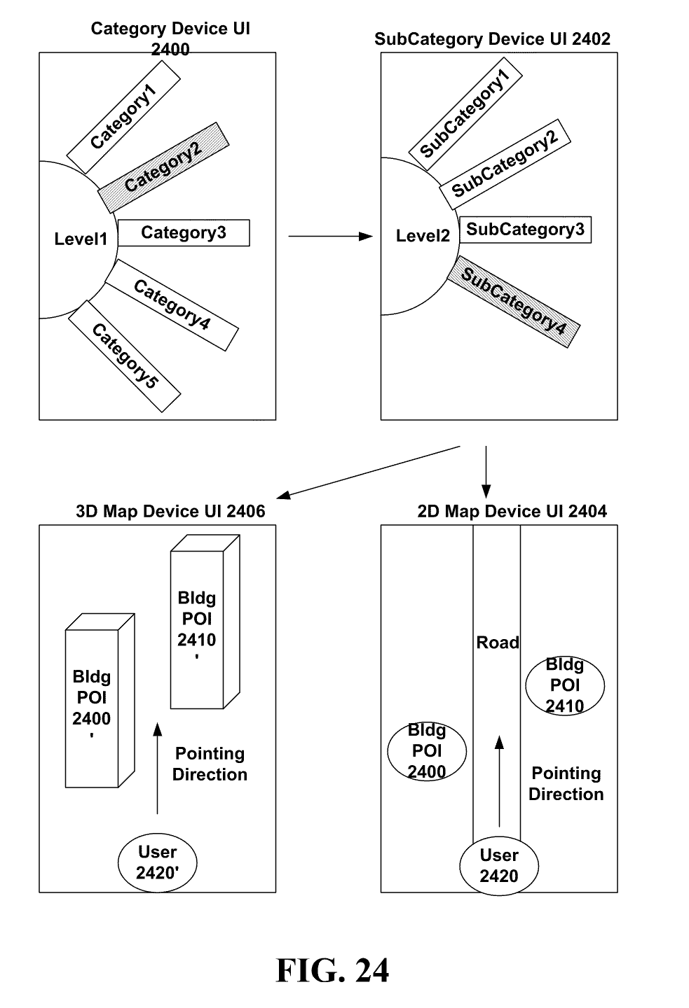

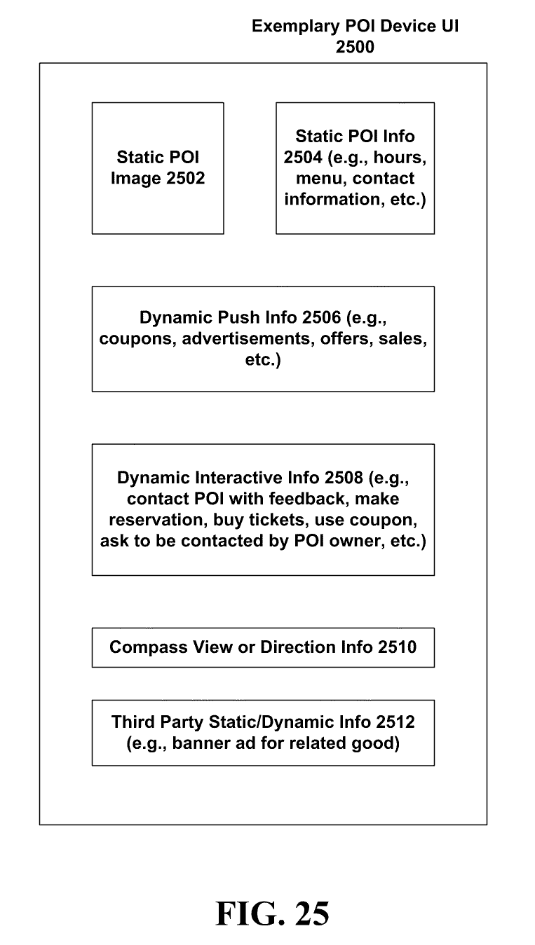

For instance, a set of different choices are shown in FIG. 24. UI 2400 and 2402 illustrate navigation of hierarchical POI information. For instance, level1 categories may include category1, category2, category3, category4 and category5, but if a user selects around the categories with a thumb-wheel, up-down control, or the like, and chooses one such as category2. Then, subcategory1, subcategory2, subcategory3 and subcategory4 are displayed as subcategories of category2. Then, if the user selects, for instance, subcategory4, perhaps few enough POIs, such as buildings 2400 and 2410 are found in the subcategory in order to display on a 2D map UI 2404 along the pointing direction, or alternatively as a 3D virtual map view 2406 along the pointing direction.

Once a single POI is implicated or selected, then a full screen view for the single POI can be displayed, such as the exemplary UI 2500. UI 2500 can have one or more of any of the following representative areas. UI 2500 can include a static POI image 2502 such as a trademark of a store, or a picture of a person. UI 2500 can also include other media, and a static POI information portion 2504 for information that tends not to change such as restaurant hours, menu, contact information, etc. In addition, UI 2500 can include an information section for dynamic information to be pushed to the user for the POI, e.g., coupons, advertisements, offers, sales, etc. In addition, a dynamic interactive information are 2508 can be included where the user can fill out a survey, provide feedback to the POI owner, request the POI to contact the user, make a reservation, buy tickets, etc. UI 2500 also can include a representation of the direction information output by the compass for reference purposes. Further, UI 2500 can include other third party static or dynamic content in area 2512.

When things change from the perspective of either the service or the client, a synchronization process can bring either the client or service, respectively, up to date. In this way, an ecosystem is enabled where a user can point at an object or point of interest, gain information about it that is likely to be relevant to the user, interact with the information concerning the point of interest, and add value to services ecosystem where the user interacts. The system thus advantageously supports both static and dynamic content.

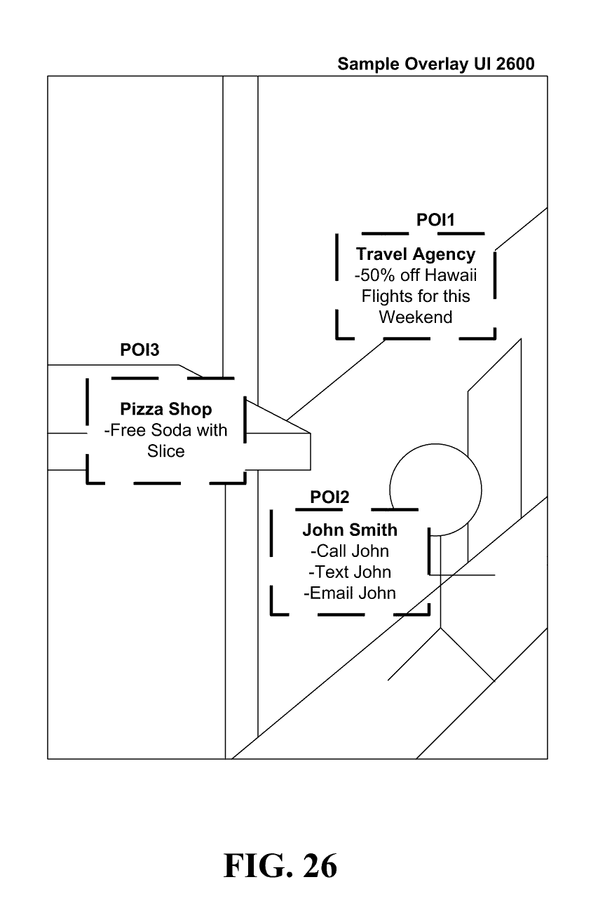

Other user interfaces can be considered such as left-right, or up-down arrangements for navigating categories or a special set of soft-keys can be adaptively provided.

Where a device includes a camera, in one embodiment shown in FIG. 26, a representative non-limiting overlay UI 2600 is shown having 3 POIs POI1, POI2 and POI3. The POIs are overlaid over actual image data being real time viewed on the device via an LCD screen or like display. The actual image data can be of products on a shelf or other display or exhibit in a store. Thus, as the user aims the camera around his or her environment, the lens becomes the pointer, and the POI information can be overlaid intelligently for discovery of endpoints of interest. Moreover, a similar embodiment can be imagined even without a camera, such as a UI in which 3-D objects are virtually represented based on real geometries known for the objects relative to the user.

Thus, the device UI can be implemented consistent with a camera, or a virtual camera, view for intuitive use of such devices. The pointer mechanism of the device could also switch based on whether the user was currently in live view mode for the camera or not. Moreover, assuming sufficient processing power and storage, real time image processing could discern an object of interest and based on image signatures, overlay POI information over such image in a similar manner to the above embodiments. In this regard, with the device provided herein, a variety of gestures can be employed to zoom in zoom out, perform tilt detection for looking down or up, or panning across a field of view to obtain a range of POIs associated with the panning scope.

With respect to a representative set of user settings, a number or maximum number of desired endpoints delivered as results can be configured. How to filter can also be configured, e.g., 5 most likely, 5 closest, 5 closest to 100 feet away, 5 within category or sub-category, alphabetical order, etc. In each case, based on a pointing direction, implicitly a cone or other cross section across physical space is defined as a scope of possible points of interest. In this regard, the width or deepness of this cone or cross section can be configurable by the user to control the accuracy of the pointing, e.g., narrow or wide radius of points and how far out to search.

To support processing of vector information and aggregating POI databases from third parties, a variety of storage techniques, such as relational storage techniques can be used. For instance, Virtual Earth data can be used for mapping and aggregation of POI data can occur from third parties such as Tele Atlas, NavTeq, etc. In this regard, businesses not in the POI database will want to be discovered and thus, the service provides a similar, but far superior from a spatial relevance standpoint, Yellow Pages experiences where businesses will desire to have their additional information, such as menus, price sheets, coupons, pictures, virtual tours, etc. accessible via the system.

In addition, a synchronization platform or framework can keep the roaming caches in sync, thereby capturing what users are looking at and efficiently processing changes. Or, where a user goes offline, local changes can be recorded, and when the user goes back online, such local changes can be synchronized to the network or service store. Also, since the users are in effect pulling information they care about in the here and in the now through the act of pointing with the device, the system generates high cost per thousand impression (CPM) rates as compared to other forms of demographic targeting. Moreover, the system drives impulse buys, since the user may not be physically present in a store, but the user may be near the object, and by being nearby and pointing at the store, information about a sale concerning the object can be sent to the user.

As mentioned, different location subsystems, such as tower triangulation, GPS, A-GPS, E-GPS, etc. have different tolerances. For instance, with GPS, tolerances can be achieved to about 10 meters. With A-GPS, tolerances can be tightened to about 12 feet. In turn, with E-GPS, tolerance may be a different error margin still. Compensating for the different tolerances is part of the interpretation engine for determining intersection of a pointing vector and a set of points of interest. In addition, as shown in FIGS. 19-21, a distance to project out the pointing vector can be explicit, configurable, contextual, etc.

In this regard, the various embodiments described herein can employ any algorithm for distinguishing among boundaries of the endpoints, such as boundary boxes, or rectangles, triangles, circles, etc. As a default radius, e.g., 150 feet could be selected, and such value can be configured or be context sensitive to the service provided. On-line real estate sites can be leveraged for existing POI information. Since different POI databases may track different information at different granularities, a way of normalizing the POI data according to one convention or standard can also be implemented so that the residential real estate location data of Zillow can be integrated with GPS information from Starbucks of all the Starbucks by country.

In addition, similar techniques can be implemented in a moving vehicle client that includes GPS, compass, accelerometer, etc. By filtering based on scenarios (e.g., I need gas), different subsets of points of interest (e.g., gas stations) can be determined for the user based not only on distance, but actual time it may take to get to the point of interest. In this regard, while a gas station may be 100 yards to the right off the highway, the car may have already passed the corresponding exit, and thus more useful information to provide is what gas station will take the least amount of time to drive from a current location based on direction/location so as to provide predictive points of interest that are up ahead on the road, and not already aged points of interest that would require turning around from one's destination in order to get to them.

For existing motor vehicle navigation devices, or other conventional portable GPS navigation devices, where a device does not natively include directional means such as a compass, the device can have an extension slot that accommodates direction information from an external directional device, such as a compass. Similarly, for laptops or other portable electronic devices, such devices can be outfitted with a card or board with a slot for a compass. While any of the services described herein can make web service calls as part of the pointing and retrieval of endpoint process, as mentioned, one advantageous feature of a user's locality in real space is that it is inherently more limited than a general Internet search for information. As a result, a limited amount of data can be predictively maintained on a user's device in cache memory and properly aged out as data becomes stale.

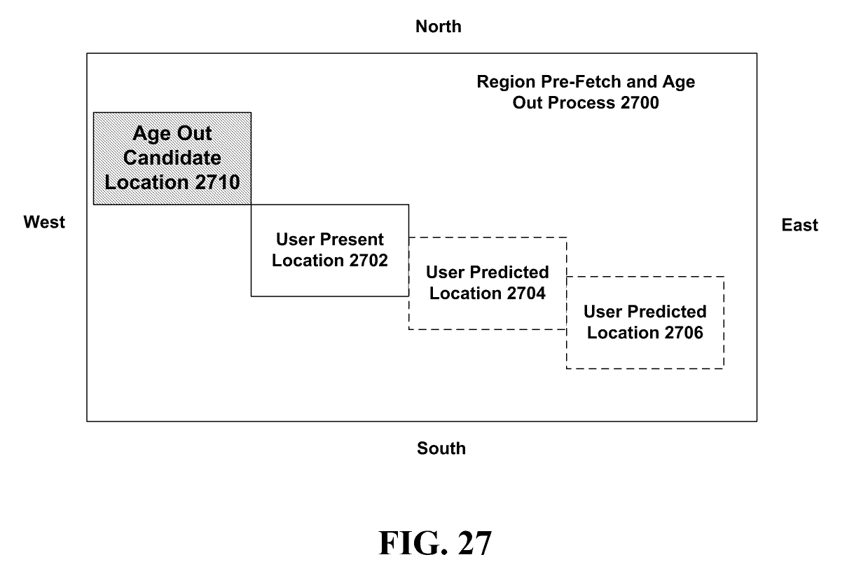

While there are a variety of implementations, and ways to sub-divide regions, whether overlapping or not, predictive caching and aging 2700 is conceptually illustrated by FIG. 27 in which a user's present location 2702 is discerned. At this point, the local cache still includes age out candidate location 2710, but as the velocity of the user indicates the user will be at predicted locations 2704 and 2706 in the future, these regions of POIs are downloaded to the mobile device. Accordingly, as the user travels to predicted location 2706, it starts to be clear that the user no longer needs the data from the age out candidate location 2710, which can then be removed, or flagged for removal when storage is challenged.

Accordingly, using the regional data cache, callbacks and an update mechanism that is updated dynamically based on movement, new point of interest can be added by a service or by a user. Update is thus performed continuously or substantially continuously based on updated travel, velocity, speed, etc. In this regard, a user can add a new point of interest in the region, add info to a local cache, and then upload to the zone. To appreciate the problem, the number of worldwide POIs is practically limitless, however only a small number of POIs will be relevant to a user at a given time. Thus, predictively, a cube of data can be taken to the device, the user can go offline such that when the user reconnects, the device is intelligent to figure out what has changed, been weighted, etc., so that the device can synchronize with the network services and expose the user's changes for other people.

The predictive algorithms again depend on what the user is interested in finding, what service the user may be using, the context of the user, etc. They can also be based on velocity, direction, time, etc. For instance, if it is nighttime, assumptions based on demographics or preferences may lead the device to return information about nightclubs or all night diners. Or, instead of giving directions as driving directions that calculate distances as absolute distances, i.e., as the crow flies, a device can take road curves into account since instantaneous pointing information on roads can be collected and handled by a corresponding service when giving driving directions. Or, as another alternative, the direction one is heading on a road, such as a highway with a concrete divider, is relevant to the directions that a navigation system should give. Where a U-turn is unavailable and user passes an exit with a point of interest, for instance, directions should take this into account and consider the heading of the vehicle.

Any device can include the embodiments described herein, including MP3 players, such as a Zune device, GPS navigation devices, bike computers, sunglass/visor systems, motor vehicles, mobile phones, laptops, PDA, etc.

One way to obtain the service applications, assuming the underlying measuring instruments to participate in the real-time gathering of directional information, is to message to a service to obtain the application, e.g., by text messaging to service, or getting a client download link. Another vehicle for enabling the service is to provide it natively in the operating system or applications of a mobile devices. Since a hardware abstraction layer accommodates different methods for collecting position, direction, acceleration information, the same platform can be used on any device regardless of the precise underlying hardware.

In another aspect of any of the embodiments described herein, because stateless messaging is employed, if communications drop with one network, the device can begin further communicating via another network. For instance, a device has two channels, and a user gets on a bus, but no longer have GPRS or GPS activity. Nonetheless the user is able to get the information the device needs from some other channel. Just because a tower, or satellites are down, does not mean that the device cannot connect through an alternative channel, e.g., the bus's GPS location information via Bluetooth.

With respect to exemplary mobile client architectures, a representative device can include, as described variously herein, client Side Storage for housing and providing fast access to cached POI data in the current region including associated dynamically updated or static information, such as annotations, coupons from businesses, etc. This includes usage data tracking and storage. In addition, regional data can be a cached subset of the larger service data, always updated based on the region in which the client is roaming. For instance, POI data could include as a non-limiting example, the following information:

| | |
|---|---|
| POI coordinates and data | //{−70.26322, 43.65412, |
| “STARBUCK'S”} | |
| Localized annotations | //Menu, prices, hours of operation, etc |
| Coupons and ads | //Classes of coupons (new user, |
| returning, etc) | |

Support for different kinds of information (e.g., blob v structured information (blob for storage and media; structured for tags, annotations, etc.)

A device can also include usage data and preferences to hold settings as well as usage data such as coupons “activated,” waypoints, businesses encountered per day, other users encountered, etc. to be analyzed by the cloud services for business intelligence analysis and reporting.

A device can also include a continuous update mechanism, which is a service that maintains the client's cached copy of a current region updated with the latest. Among other ways, this can be achieved with a ping-to-pull model that pre-fetches and swaps out the client's cached region using travel direction and speed to facilitate roaming among different regions. This is effectively a paging mechanism for upcoming POIs. This also includes sending a new or modified POI for the region (with annotations+coupons), sending a new or modified annotation for the POIs (with coupons), or sending a new or modified coupon for the POI.

A device can also include a Hardware Abstraction Layer (HAL) having components responsible for abstracting the way the client communicates with the measuring instruments, e.g., the GPS driver for positioning and LOS accuracy (e.g., open eGPS), magnetic compass for heading and rotational information (e.g., gyroscopic), one or more accelerometers for gestured input and tilt (achieves 3D positional algorithms, assuming gyroscopic compass).

As described earlier, a device can also include methods/interfaces to make REST calls via GPRS/Wi-Fi and a file system and storage for storing and retrieving the application data and settings.

A device can also include user input and methods to map input to the virtual keys. For instance, one non-limiting way to accomplish user input is to have softkeys as follows, though it is to be understood a great variety of user inputs can be used to achieve interaction with the user interfaces of the pointing based services.

SK up/down: //Up and down on choices

| | |
|---|---|
| SK right, SK ok/confirm: | //Choose an option or drill down/next |
| page | |
| SK left, SK cancel/back, | //Go back to a previous window, cancel |
| Exit / Incoming Call events | //Exit the app or minimize |

In addition, a representative device can include a graphics and windowing stack to render the client side UI, as well as an audio stack to play sounds/alerts.

As mentioned, such a device may also include spatial and math computational components including a set of APIs to perform 3D collision testing between subdivided surfaces such as spherical shells (e.g., a simple hit testing model to adopt and boundary definitions for POIs), rotate points, and cull as appropriate from conic sections.

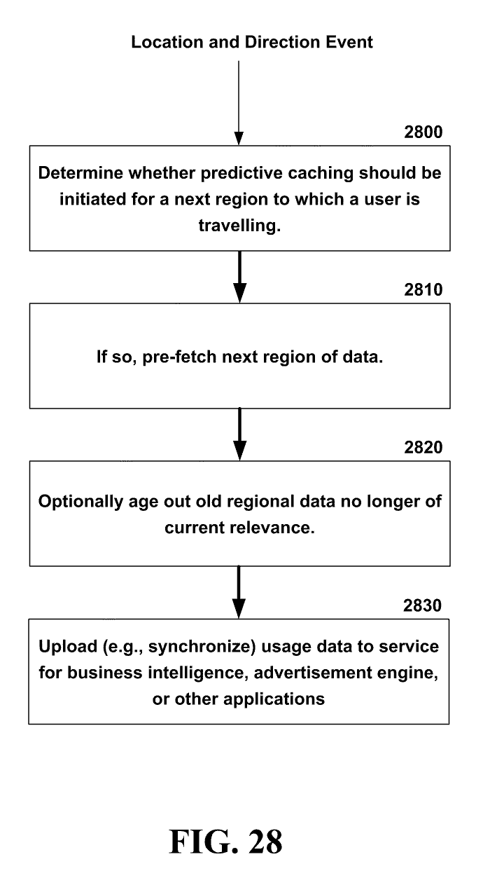

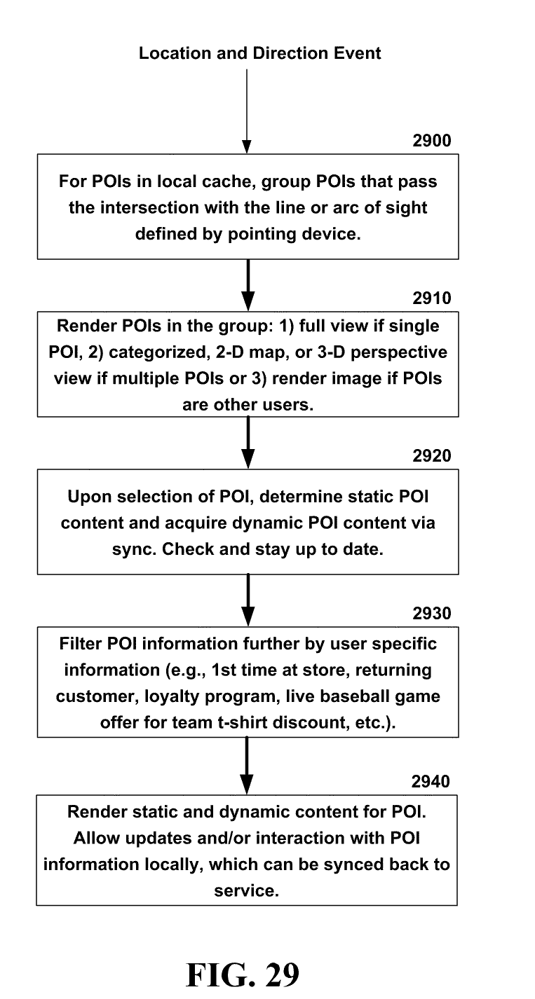

As described in various embodiments herein, FIGS. 28 and 29 illustrate two processes for a device when location (e.g., GPS) and direction (e.g., compass) events occur. In FIG. 28, upon the occurrence of a location or direction event, at 2800, it is determined whether predictive caching should be initiated for a next region to which a user is travelling. At 2810, if so, then the next region of data can be pre-fetched. At 2820, old regional data no longer of relevance can be aged out. At 2830, any usage data can be uploaded to the service framework for business intelligence, input to an advertisement engine, etc.

FIG. 29 represents another process for filtering potential POIs after a pointing event. Upon the detection of a location and direction event, at 2900, for POIs in the device's local cache, a group of POIs are determined that pass an intersection algorithm for the direction of pointing of the device. At 2910, POIs in the group can be represented in some fashion on a UI, e.g., full view if only 1 POI, categorized view, 2-D map view, 3-D perspective view, or user images if other users, etc. The possibilities for representation are limitless; the embodiments described herein are intuitive based on the general notion of pointing based direction services.

At 2920, upon selection of a POI, static content is determined and any dynamic content is acquired via synchronization. When new data becomes available, it is downloaded to stay up to date. At 2930, POI information is filtered further by user specific information (e.g., if it is the user's first time at the store, returning customer, loyalty program member, live baseball game offer for team clothing discounts, etc.). At 2940, static and dynamic content that is up to date is rendered for the POI. In addition, updates and/or interaction with POI information is allowed which can be synced back to the service.

### Exemplary Networked and Distributed Environments

One of ordinary skill in the art can appreciate that the various embodiments of methods and devices for pointing based services and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

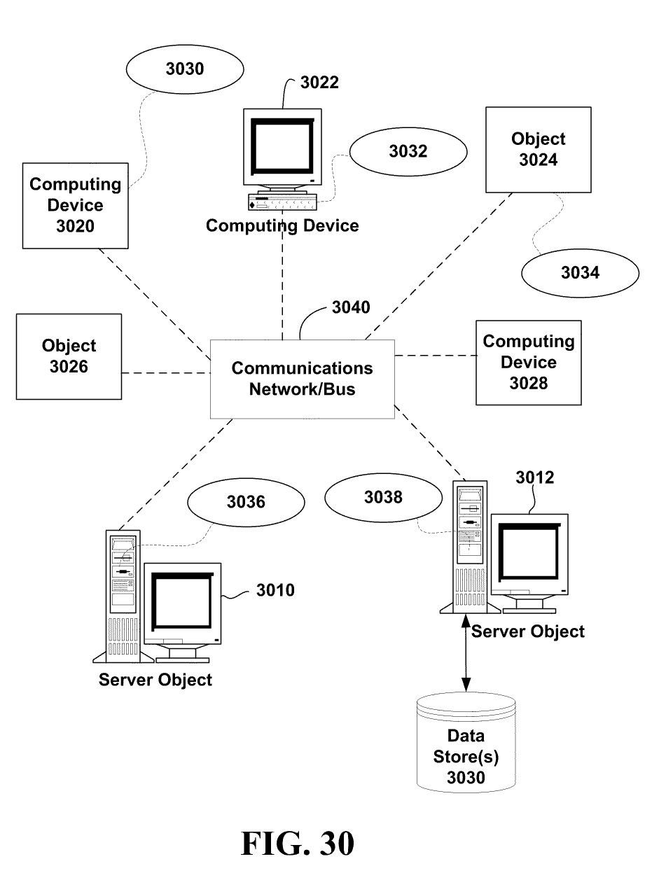

FIG. 30 provides a non-limiting schematic diagram of an exemplary networked or distributed computing environment. The distributed computing environment comprises computing objects 3010, 3012, etc. and computing objects or devices 3020, 3022, 3024, 3026, 3028, etc., which may include programs, methods, data stores, programmable logic, etc., as represented by applications 3030, 3032, 3034, 3036, 3038. It can be appreciated that objects 3010, 3012, etc. and computing objects or devices 3020, 3022, 3024, 3026, 3028, etc. may comprise different devices, such as PDAs, audio/video devices, mobile phones, MP3 players, laptops, etc.

Each object 3010, 3012, etc. and computing objects or devices 3020, 3022, 3024, 3026, 3028, etc. can communicate with one or more other objects 3010, 3012, etc. and computing objects or devices 3020, 3022, 3024, 3026, 3028, etc. by way of the communications network 3040, either directly or indirectly. Even though illustrated as a single element in FIG. 30, network 3040 may comprise other computing objects and computing devices that provide services to the system of FIG. 30, and/or may represent multiple interconnected networks, which are not shown. Each object 3010, 3012, etc. or 3020, 3022, 3024, 3026, 3028, etc. can also contain an application, such as applications 3030, 3032, 3034, 3036, 3038, that might make use of an API, or other object, software, firmware and/or hardware, suitable for communication with or implementation of the delayed interaction model as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, hub and spoke, or hybrid architectures, can be utilized. In a client/server architecture, particularly a networked system, a client is usually a computer that accesses shared network resources provided by another computer, e.g., a server. In the illustration of FIG. 30, as a non-limiting example, computers 3020, 3022, 3024, 3026, 3028, etc. can be thought of as clients and computers 3010, 3012, etc. can be thought of as servers where servers 3010, 3012, etc. provide data services, such as receiving data from client computers 3020, 3022, 3024, 3026, 3028, etc., storing of data, processing of data, transmitting data to client computers 3020, 3022, 3024, 3026, 3028, etc., although any computer can be considered a client, a server, or both, depending on the circumstances. Any of these computing devices may be processing data, or requesting services or tasks that may implicate the delayed interaction model and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the direction based services can be provided standalone, or distributed across multiple computing devices or objects.

In a network environment in which the communications network/bus 3040 is the Internet, for example, the servers 3010, 3012, etc. can be Web servers with which the clients 3020, 3022, 3024, 3026, 3028, etc. communicate via any of a number of known protocols, such as the hypertext transfer protocol (HTTP). Servers 3010, 3012, etc. may also serve as clients 3020, 3022, 3024, 3026, 3028, etc., as may be characteristic of a distributed computing environment.

### Exemplary Computing Device

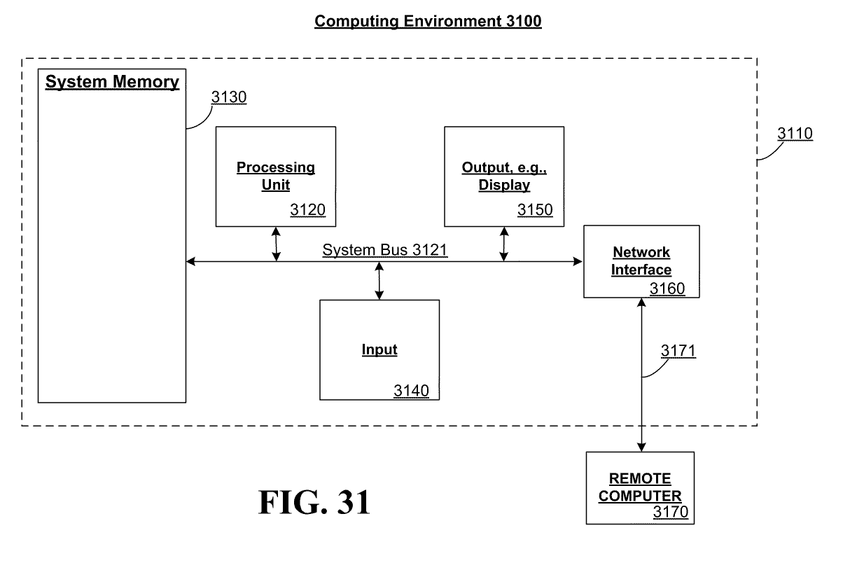

As mentioned, various embodiments described herein apply to any device wherein it may be desirable to perform pointing based services, and delay interactions with points of interest. It should be understood, therefore, that handheld, portable and other computing devices and computing objects of all kinds are contemplated for use in connection with the various embodiments described herein, i.e., anywhere that a device may request pointing based services. Accordingly, the below general purpose remote computer described below in FIG. 31 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 31 thus illustrates an example of a suitable computing system environment 3100 in which one or more of the embodiments may be implemented, although as made clear above, the computing system environment 3100 is only one example of a suitable computing environment and is not intended to suggest any limitation as to the scope of use or functionality of any of the embodiments. Neither should the computing environment 3100 be interpreted as having any dependency or requirement relating to any one or combination of components illustrated in the exemplary operating environment 3100.

With reference to FIG. 31, an exemplary remote device for implementing one or more embodiments herein can include a general purpose computing device in the form of a handheld computer 3110. Components of handheld computer 3110 may include, but are not limited to, a processing unit 3120, a system memory 3130, and a system bus 3121 that couples various system components including the system memory to the processing unit 3120.

Computer 3110 typically includes a variety of computer readable media and can be any available media that can be accessed by computer 3110. The system memory 3130 may include computer storage media in the form of volatile and/or nonvolatile memory such as read only memory (ROM) and/or random access memory (RAM). By way of example, and not limitation, memory 3130 may also include an operating system, application programs, other program modules, and program data.

A user may enter commands and information into the computer 3110 through input devices 3140 A monitor or other type of display device is also connected to the system bus 3121 via an interface, such as output interface 3150. In addition to a monitor, computers may also include other peripheral output devices such as speakers and a printer, which may be connected through output interface 3150.

The computer 3110 may operate in a networked or distributed environment using logical connections to one or more other remote computers, such as remote computer 3170. The remote computer 3170 may be a personal computer, a server, a router, a network PC, a peer device or other common network node, or any other remote media consumption or transmission device, and may include any or all of the elements described above relative to the computer 3110. The logical connections depicted in FIG. 31 include a network 3171, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to derive information about surrounding points of interest.

There are multiple ways of implementing one or more of the embodiments described herein, e.g., an appropriate API, tool kit, driver code, operating system, control, standalone or downloadable software object, etc. which enables applications and services to use the pointing based services. Embodiments may be contemplated from the standpoint of an API (or other software object), as well as from a software or hardware object that provides pointing platform services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A computer-implemented method for providing information about points of interest (POIs) in a direction-based services system, comprising:
receiving a query for a set of POIs of the direction-based services system;
identifying a computing device relating to the query;
based on the query and a POI interaction profile managed for the computing device, the POI interaction profile formed from aggregate interaction data representing interactions with POIs of the direction-based services system by the computing device as a function of direction and location of the computing device, analyzing the aggregate interaction data for the computing device; and
outputting a set of POIs of threshold relevance to the computing device based on the analyzing.

2. The method of claim 1, wherein the identifying includes implicitly identifying the computing device and the POI interaction profile via login credentials.

3. The method of claim 1, further comprising:
displaying the set of POIs output by the outputting.

4. The method of claim 3, further comprising:
receiving a request to display additional information about at least one of the POIs of the set.

5. The method of claim 4, further comprising:
in response to the receiving of the request to display the additional information, retrieving and displaying the additional information corresponding to the at least one of the POIs.

6. The method of claim 5, wherein the additional information corresponding to the at least one of the POIs includes an advertisement.

7. The method of claim 6, wherein the advertisement relates to the at least one of the POIs.

8. The method of claim 6, wherein the advertisement relates to one of the POIs of the set, which is not the at least one of the POIs about which additional information has been requested.

9. The method of claim 1, wherein analyzing the aggregated interaction data for the computing device further comprises analyzing prior interactions with POIs by the computing device.

10. The method of claim 1, wherein analyzing the aggregated interaction data for the computing device further comprises analyzing the interactions of other computing devices with POIs of the set.

11. The method of claim 10, wherein analyzing the interactions of other computing devices with POIs of the set further comprises using collaborative filtering.

12. The method of claim 1, wherein the received query comprises a category of POIs.

13. The method of claim 12, wherein analyzing the aggregated interaction data for the computing device further comprises analyzing a historical usage pattern of POIs in the category.

14. The method of claim 13, wherein the outputting a set of POIs further comprises outputting a set of POIs based at least in part on the historical usage pattern.

15. The method of claim 14, wherein the outputting a set of POIs further comprises outputting a set of POIs based at least in part on independent ratings.

16. A system for analyzing information about points of interest (POIs) from direction-based services, comprising:
a receiving component that receives data about at least one interaction with at least one identified point of interest (POI) via direction-based services by at least one computing device;
an analysis component that determines a computing device associated with the data, associates the data with the computing device and statistically analyzes the data to identify at least one trend associated with the at least one interaction with the at least one POI.

17. The system of claim 16, wherein the analysis component statistically analyzes the data based on interactions with the at least one POI by a plurality of devices associated with different users.

18. The system of claim 16, wherein the analysis component statistically analyzes the data based on interactions with the at least one POI by at least one device associated with a subset of users.

19. The system of claim 16, wherein the analysis component statistically analyzes the data based on interactions with the at least one POI by a device associated with a single user.

20. The system of claim 16, further comprising:
a display component including an interface for rendering a tailored set of POIs based on an analysis of the collected data about the at least one interaction by the at least one computing device.

21. The system of claim 16, further comprising:
an advertising component for rendering tailored advertising content determined based at least in part on an analysis of the collected data about the at least one interaction by the at least one computing device.

22. The system of claim 21, wherein the tailored advertising content is additionally determined based at least in part on a profile of a user of the at least one computing device.

23. The system of claim 21, wherein the tailored advertising content is additionally determined based at least in part on an analysis of data collected about the interaction of a plurality of users of the system.

24. A computer-implemented method comprising:
requesting information about at least one of a set of points of interest (POIs) of a direction-based location services system, the set of POIs including characteristics determined by the direction-based location services system based on aggregated stored data relating to interactions with the set of POIs by a plurality of computing devices participating in the direction-based location services system;
receiving, based upon an analysis of the characteristics of the set of POIs, at least one advertisement corresponding to the at least one of the set of POIs; and
displaying the at least one advertisement.

25. The method of claim 24, further comprising:
receiving the requested information about the at least one POI from the direction-based location services system.
